(19) United States
(12) Patent Application Publication
(10) Pub. No.: US 2014/0020188 A1
(43) Pub. Date: Jan. 23, 2014

(54) COMPOSITIONS COMPRISING HYDROPHOBICALLY MODIFIED CATIONIC POLYMERS

(71) Applicant: The Procter & Gamble Company, Cincinnati, OH (US)

(72) Inventors: Yonas Gizaw, West Chester, OH (US); Roy Jerome Harrington, Liberty Township, OH (US); Daniel Jerome White, JR., West Chester, OH (US); Frank Hulskotter, Bad Duerkheim (DE); Steven Daryl Smith, Fairfield, OH (US); Peter Herbert Koenig, Montgomery, OH (US); Sumanth Narahari Jamadagni, West Chester, OH (US); Matthew Scott Wagner, Cincinnati, OH (US); Steven Hardy Page, Lawrenceburg, IN (US); Ouidad Benlahmar, Mannheim (DE); Volodymyr Boyko, Mannheim (DE); Aaron Flores Figueroa, Mannheim (DE); Sophia Rosa Ebert, Mannheim (DE)

(73) Assignee: The Procter & Gamble Company, Cincinnati, OH (US)

(21) Appl. No.: 13/945,939

(22) Filed: Jul. 19, 2013

Related U.S. Application Data
(60) Provisional application No. 61/673,600, filed on Jul. 19, 2012.
(60) Provisional application No. 61/676,652, filed on Jul. 27, 2012.

(51) Int. Cl. C11D 3/00

(52) U.S. Cl. CPC C11D 3/0036
USPC 8/137; 510/299

(57) ABSTRACT

This invention relates to compositions comprising hydrophobically modified cationic polymers as well as processes of making and using such compositions. Such hydrophobically modified cationic polymers may be added to the composition in a variety of ways including, but not limited to, as a component of a particle. Advantages of such compositions include the ability to selectively increase the deposition of benefit agents without effectively increasing deposition of undesired materials.

### FIELD OF INVENTION

This invention relates to compositions comprising hydrophobically modified cationic polymers as well as processes of making and using such compositions.

### BACKGROUND

Consumer products typically comprise benefit agents that provide, for example, freshness, feel, anti-dandruff benefits, etc. Such benefit agents are typically expensive and/or can bring negatives such as stability negatives, particularly when such benefit agents are used at high levels. As a result, the industry has attempted to increase the effectiveness of such benefit agents via increasing the deposition of such benefit agents through the use of a deposition aid. Unfortunately, deposition aids, while increasing the deposition of the desired benefit agent, can also increase the deposition of undesired materials such as soil and/or alter the nature of the desired benefit agent. When the deposition aid deposits soil; whiteness, feel, and/or cleaning benefits are decreased. When the nature of the desired benefit agent is negatively impacted by the deposition aid, the benefit agent's effectiveness may be decreased and/or the consumer experience arising from the benefit agent's use may be altered in a negative manner. For several decades the contradiction between effective benefit agent deposition and undesired deposition of materials, such as soil, has not been sufficiently resolved.

Applicants recognized that deposition aids undergo hydrophobic and/or electrostatic interactions with not only benefit agents, but also materials, such as soils, to form particulates that have an affinity for consumer relevant substrates such as hair, skin, fabrics, and/or hard surfaces. Such interactions may be particularly pronounced in the presence of surfactants. Thus, Applicants recognized the source of the problem that has been the barrier to the resolution to benefit agent deposition without and/or minimized deposition negatives. As a result of such recognition, Applicants provide a solution to such aforementioned problem herein.

### SUMMARY OF THE INVENTION

This invention relates to compositions comprising hydrophobically modified cationic polymers as well as processes of making and using such compositions.

### DETAILED DESCRIPTION

As used herein “consumer product” means baby care, beauty care, fabric & home care, family care, feminine care, health care, snack and/or beverage products or devices generally intended to be used or consumed in the form in which it is sold. Such products include but are not limited to diapers, bibs, wipes; products for and/or methods relating to treating hair (human, dog, and/or cat), including, bleaching, coloring, dyeing, conditioning, shampooing, styling; deodorants and antiperspirants; personal cleansing; cosmetics; skin care including application of creams, lotions, and other topically applied products for consumer use including fine fragrances; and shaving products, products for and/or methods relating to treating fabrics, hard surfaces and any other surfaces in the area of fabric and home care, including: air care including air fresheners and scent delivery systems, car care, dishwashing, fabric conditioning (including softening and/or freshening), laundry detergency, laundry and rinse additive and/or care, hard surface cleaning and/or treatment including floor and toilet bowl cleaners, and other cleaning for consumer or institutional use; products and/or methods relating to bath tissue, facial tissue, paper handkerchiefs, and/or paper towels; tampons, feminine napkins; products and/or methods relating to oral care including toothpastes, tooth gels, tooth rinses, denture adhesives, tooth whitening; over-the-counter health care including cough and cold remedies, pain relievers, RX pharmaceuticals, pet health and nutrition; processed food products intended primarily for consumption between customary meals or as a meal accompaniment (non-limiting examples include potato chips, tortilla chips, popcorn, pretzels, corn chips, cereal bars, vegetable chips or crisps, snack mixes, party mixes, multigrain chips, snack crackers, cheese snacks, pork rinds, corn snacks, pellet snacks, extruded snacks and bagel chips); and coffee.

In the context of the present invention, the terms “a” and “an” mean at “at least one”.

As used herein, the terms “include”, “includes” and “including” are meant to be non-limiting.

As used herein, the term “fluid” includes liquid, gel, and paste product forms.

As used herein, the term “situs” includes paper products, fabrics, garments, hard surfaces, hair and skin.

As used herein, when a polymer is said to contain or comprise a monomer, it is understood that this is synonymous with a residue of such monomer

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Particle, and Methods of Making and Using Same

In one aspect, a fabric and home care composition comprising:
a) a hydrophobically modified cationic polymer, said hydrophobically modified cationic polymer having the formula:

PᵣSₓ
wherein r is a number from about 10 to about 10,000, and S is a hydrophobic moiety and the index x is a number from about 1 to a number that is equal to about r/10; and P is selected from the group consisting of:
(i) a polyethyleneimine;
(ii) a substituted polyethyleneimine;
(iii) a synthetic polymer comprising a residue of a monomers selected from the group consisting of N,N-dialkylaminoalkyl acrylate; N,N-dialkylaminoalkyl methacrylate; N,N-dialkylaminoalkyl acrylamide; N,N-dialkylaminoalkylmethacrylamide; quaternized N,N dialkylaminoalkyl acrylate; quaternized N,N-dialkylaminoalkyl methacrylate; quaternized N,N-dialkylaminoalkyl acrylamide; quaternized N,N-dialkylaminoalkylmethacrylamide; Methacryloamidopropyl-pentamethyl-1,3-propylene-2-ol-ammonium dichloride; N,N,N,N′,N′,N″,N″-heptamethyl-N″-3-(1-oxo-2-methyl-2-propenyl)aminopropyl-9-oxo-8-azo-decane-1,4,10-triammonium trichloride; vinylamine; allylamine; vinyl imidazole; quaternized vinyl imidazole; diallyl dialkyl ammonium chloride, N-vinyl pyrrolidone, glycidyl methacrylate, acrylamide, N-alkyl acrylamide and mixtures thereof;
   and S has the formula

J_{q}W
wherein:
the index q is 0 or 1; and
each J comprises a moiety selected from the group consisting of

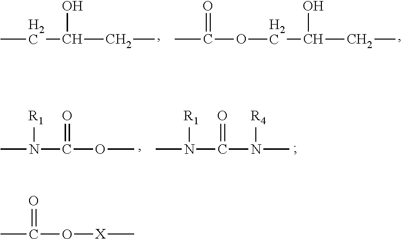

and mixtures thereof wherein each R₁ and R₄ is independently selected from hydrogen or a C₁ to C₄ alkyl, in one aspect R₁ and R₄ are hydrogen; in one aspect J is selected from the group consisting of

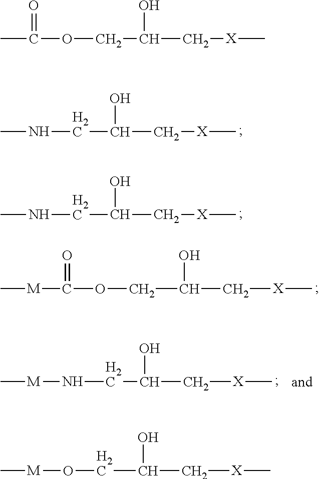

each X and M are divalent alkylene radicals which are optionally interrupted with N or O, in one aspect X is selected from the group consisting of

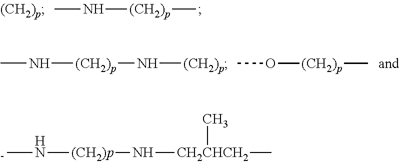

p is an integer from 1-4
and
W comprises a siloxane polymer or a functionalized siloxane polymer, in one aspect, said siloxane polymer is polydimethylsiloxane and said functionalized siloxane polymer is functionalized polydimethylsiloxane;
b) optionally, a benefit agent;
c) optionally, a surfactant selected from the group consisting of anionic surfactants, cationic surfactants, non-ionic surfactants, amphoteric surfactants and mixtures thereof
   is disclosed.

In one aspect, P is selected from the group consisting of:
(i) a polyethyleneimine;
(ii) a substituted polyethyleneimine;
(iii) a synthetic polymer comprising a residue of a monomers selected from the group consisting of N,N-dialkylaminoalkyl acrylate; N,N-dialkylaminoalkyl methacrylate; N,N-dialkylaminoalkyl acrylamide; N,N-dialkylaminoalkylmethacrylamide; quaternized N,N dialkylaminoalkyl acrylate; quaternized N,N-dialkylaminoalkyl methacrylate; quaternized N,N-dialkylaminoalkyl acrylamide; quaternized N,N-dialkylaminoalkylmethacrylamide; Methacryloamidopropyl-pentamethyl-1,3-propylene-2-ol-ammonium dichloride; N,N,N,N′,N′,N″,N″-heptamethyl-N″-3-(1-oxo-2-methyl-2-propenyl)aminopropyl-9-oxo-8-azo-decane-1,4,10-triammonium trichloride; vinylamine; allylamine; vinyl imidazole; quaternized vinyl imidazole; diallyl dialkyl ammonium chloride, and mixtures thereof.

In one aspect, P is a random copolymer that comprises, based on total random copolymer weight, a residue of a monomer selected from the group consisting of diallyl dialkyl ammonium chloride, N-vinyl pyrrolidone, glycidyl methacrylate, acrylamide, N-alkyl acrylamide and mixtures thereof.

In one aspect, The fabric and home care composition of claim 3 wherein P is a random copolymer that comprises, based on total random copolymer weight:
(i) from about 0 weight percent to about 80 weight percent, from about 5 weight percent to about 70 weight percent, or from about 10 weight percent to about 60 weight percent of a residue of N-vinyl pyrrolidone;
(ii) from about 0.01 weight percent to about 20 weight percent, from about 0.05 weight percent to about 15 weight percent, or from about 0.5 weight percent to about 10 weight percent of a residue of glycidyl methacrylate;
(iii) from about 5 weight percent to about 95 weight percent, from about 10 weight percent to about 90 weight percent, or from about 15 weight percent to about 70 weight percent of a residue of diallyldimethylammonium chloride;
(iv) from about 5 weight percent to about 95 weight percent, from about 10 weight percent to about 90 weight percent, or from about 15 weight percent to about 70 weight percent of a residue of acrylamide;
(v) from about 5 weight percent to about 95 weight percent, preferably from about 10 weight percent to about 90 weight percent, or from about 15 weight percent to about 70 weight percent of a residue of N-alkyl acrylamide; and
(vi) combinations of (i) through (v);
with the proviso that the total sum of said residues does not exceed 100%.

In one aspect, said hydrophobically modified cationic polymer is a layering material that is disposed, at least in part, on a particle comprising a core having an outer surface and one or more layering materials, said particle having a particle size of from about 0.02 um to about 500 um; from about 0.04 um to 250 um; from about 0.08 um to about 100 um; or from about 0.20 um to about 60 um.

In one aspect, said hydrophobically modified cationic polymer is disposed on the outer surface of said core of said particle.

Thus said particle and a composition comprising said particle is disclosed.

In one aspect, said composition is a fabric and home care composition.

In one aspect, said fabric and home care composition comprises a benefit agent, the ratio of said benefit agent to hydrophobically modified cationic polymer being from about 40:1 to about 5:1; from about 35:1 to about 7:1, from about 30:1 to about 10:1, from about 20:1 to about 15:1.

In one aspect, said benefit agent is selected from the group consisting of a silicone, a vinyl polymer, a polyether, a material comprising a hydrocarbon wax, a hydrocarbon liquid, a fluid sugar polyester, a fluid sugar polyether, perfume raw materials, perfume delivery system, silicone oils, waxes, hydrocarbons, higher fatty acids, essential oils, lipids, skin coolants, vitamins, sunscreens, antioxidants, glycerine, catalysts, bleach particles, silicon dioxide particles, malodor reducing agents, odor-controlling materials, chelating agents, antistatic agents, softening agents, insect and moth repelling agents, colorants, antioxidants, chelants, bodying agents, drape and form control agents, smoothness agents, wrinkle control agents, sanitization agents, disinfecting agents, germ control agents, mold control agents, mildew control agents, antiviral agents, drying agents, stain resistance agents, soil release agents, fabric refreshing agents and freshness extending agents, chlorine bleach odor control agents, dye fixatives, dye transfer inhibitors, color maintenance agents, optical brighteners, color restoration/rejuvenation agents, anti-fading agents, whiteness enhancers, anti-abrasion agents, wear resistance agents, fabric integrity agents, anti-wear agents, anti-pilling agents, defoamers, anti-foaming agents, UV protection agents, sun fade inhibitors, anti-allergenic agents, enzymes, water proofing agents, a fabric hueing dye, fabric comfort agents, shrinkage resistance agents, stretch resistance agents, stretch recovery agents, skin care agents, glycerin, and natural actives, antibacterial actives, antiperspirant actives, cationic polymers, dyes and mixtures thereof.

In one aspect, said benefit agent comprises a silicone.

In one aspect, said silicone has a viscosity from about 10 centistokes (cSt) to about 2,000,000 cSt; from about 50 cSt to about 1,000,000 cSt; from about 500 cSt to about 100,000 cSt; or from about 750 cSt to about 1000 cSt.

In one aspect, said silicone comprises an organofunctional silicone.

In one aspect, said organofunctional silicone has the structure:

[R₁R₂R₃SiO_{1/2}]₍ⱼ₊₂₎[R₄Si(X-Z)O_{2/2}]ₖ[R₄R₄SiO_{2/2}]ₘ[R₄SiO_{3/2}]ⱼ

wherein:
j is an integer from 0 to about 98; in one aspect j is an integer from 0 to about 48; in one aspect, j is 0;
k is an integer from 0 to about 200; in one aspect, k is an integer from 0 to about 50; when k=0, at least one of R₁, R₂ or R₃=—X-Z,
m is an integer from 4 to about 5,000; in one aspect m is an integer from about 10 to about 4,000; in another aspect m is an integer from about 50 to about 2,000;
R₁, R₂ and R₃ are each independently selected from the group consisting of H, OH, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, C₁-C₃₂ alkoxy, C₁-C₃₂ substituted alkoxy and X-Z; each R₄ is independently selected from the group consisting of H, OH, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, C₁-C₃₂ alkoxy and C₁-C₃₂ substituted alkoxy; for each X-Z,
   X comprises a divalent alkylene radical comprising 2-12 carbon atoms; and
   at least one Z in the said organosiloxane is selected from the group consisting of R₅;

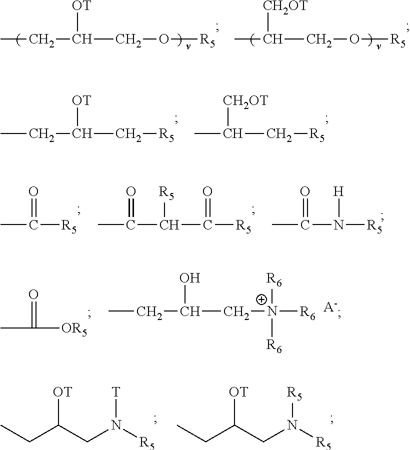

each additional Z in said organosilicone is independently selected from the group comprising of H, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, R₅,

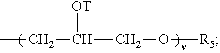

each R₅ is independently selected from the group consisting of H; C₁-C₃₂ alkyl; C₁-C₃₂ substituted alkyl, C₅-C₃₂ or C₆-C₃₂ aryl, C₅-C₃₂ or C₆-C₃₂ substituted aryl or C₆-C₃₂ alkylaryl, or C₆-C₃₂ substituted alkylaryl, —(CHR₆—CHR₆—O—)_{w}—CHR₆—CHR₆-L and a siloxyl residue;
   w is an integer from 0 to about 500, in one aspect w is an integer from 0 to about 200, one aspect w is an integer from 0 to about 50;
   each R₆ is independently selected from H or a C₁-C₁₈ alkyl; wherein each L is independently selected from

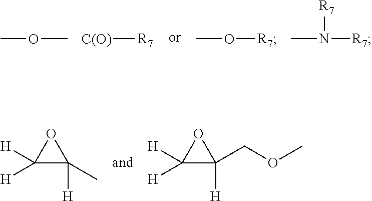

each R₇ is independently selected from the group consisting of H; C₁-C₃₂ alkyl; C₁-C₃₂ substituted alkyl, C₅-C₃₂ or C₆-C₃₂ aryl, C₅-C₃₂ or C₆-C₃₂ substituted aryl, C₆-C₃₂ alkylaryl, and C₆-C₃₂ substituted aryl, and a siloxyl residue;
each T is independently selected from H;

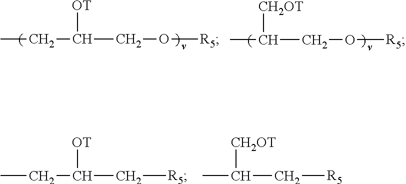

wherein each v in said organosilicone is an integer from 1 to about 10, in one aspect, v is an integer from 1 to about 5 and the sum of all v indices in each Z in the said organosilicone is an integer from 1 to about 30 or from 1 to about 20 or from 1 to about 10, with the proviso that the total moieties T in a molecule does not exceed 6.
In one aspect, said synthetic polymer comprises a residue of an ethylenically unsaturated monomer.
In one aspect, said ethylenically unsaturated monomer is selected from the group consisting of acrylamide; N,N-dialkyl acrylamide; methacrylamide; N,N-dialkylmethacrylamide; C₁-C₁₂ alkyl acrylate; C₁-C₁₂ hydroxyalkyl acrylate; polyalkylene glycol acrylate; C₁-C₁₂ alkyl methacrylate; C₁-C₁₂ hydroxyalkyl methacrylate; polyalkylene glycol methacrylate; vinyl acetate; vinyl alcohol; vinyl formamide; vinyl acetamide; vinyl alkyl ether; vinyl pyridine; vinyl pyrrolidone; vinyl morpholine; acryloyl morpholine; acrylic acid; methacrylic acid; maleic acid; vinyl sulfonic acid; styrene sulfonic acid; acrylamidopropylmethane sulfonic acid, salts of acrylic acid; salts of methacrylic acid; salts of maleic acid; salts of vinyl sulfonic acid; salts of styrene sulfonic acid; salts of acrylamidopropylmethane sulfonic acid, esterified acrylic acid; esterified methacrylic acid; esterified maleic acid; esterified vinyl sulfonic acid; esterified styrene sulfonic acid; esterified acrylamidopropylmethane sulfonic acid, amidated acrylic acid; amidated methacrylic acid; amidated maleic acid; amidated vinyl sulfonic acid; amidated styrene sulfonic acid; amidated acrylamidopropylmethane sulfonic acid; ethylene glycoldiacrylate; divinylbenzene; butadiene and mixtures thereof.
In one aspect, said fabric and home care composition comprises one or more additives in addition to said benefit agent, said additives being selected from the group consisting of bleach, bleach activators, surfactants, builders, chelating agents, dye transfer inhibiting agents, dispersants, enzymes, enzyme stabilizers, catalytic metal complexes, polymers, polymeric dispersing agents, clay and soil removal/anti-redeposition agents, brighteners, suds suppressors, dyes, perfumes, perfume delivery systems, structure elasticizing agents, fabric softeners, carriers, hydrotropes, solvents, processing aids, and pigments.
In one aspect, a method of treating a situs comprising optionally, washing and/drying a situs, contacting a situs with a composition according to any of the fabric and home care compositions disclosed herein then optionally, washing and/drying said situs.

In one aspect, a particle having a particle size of from about 0.02 um to about 500 um; from about 0.04 um to 250 um; from about 0.08 um to about 100 um; or from about 0.20 um to about 60 um; said particle comprising a core and a layering material disposed at least in part on the exterior surface of said core:
a) said core comprising a first benefit agent;
b) said layering material comprises a hydrophobically modified cationic polymer, said hydrophobically modified cationic polymer having the formula:

PᵣSₓ
wherein r is a number from about 10 to about 10,000, and S is a hydrophobic moiety and the index x is a number from about 1 to a number that is equal to about r/10; and P is selected from the group consisting of:
   (i) a polyamine, in one aspect, a polyethyleneimine;
   (ii) a copolymer comprising acrylamide and a neutral, cationic, and/or anionic vinyl monomer;
   (iii) a polyvinylformamide; in one aspect, said polyvinylformamide may be partially or fully hydrolyzed;
   (iv) a copolymer comprising vinyl formamide and a neutral, cationic, and/or anionic vinyl monomer; in one aspect, said vinylformamide may be partially or fully hydrolyzed;
   (v) a copolymer comprising vinylpyrrolidone and a neutral, cationic, and/or anionic vinyl monomer;
   (vi) an amine-epichlorohydrin polymer; in one aspect, said amine-epichlorohydrin polymer may be chemically modified;
   (vii) a copolymer comprising vinylimidazole and a neutral, cationic, and/or anionic vinyl monomer; in one aspect, said vinylimidazole is quaternized;
   (viii) a copolymer comprising diallyldimethylammonium chloride and a neutral, cationic, and/or anionic vinyl monomer;
   (ix) a copolymer comprising methacryloylpropyltrimethylammonium chloride and a neutral, cationic, and/or anionic vinyl monomer;
   (x) a copolymer comprising acryloylpropyltrimethylammonium chloride and a neutral, cationic, and/or anionic vinyl monomer;
   (xi) a copolymer comprising (3-methacrylamidopropyl)trimethylammonium chloride and a neutral, cationic, and/or anionic vinyl monomer; and
   (xii) mixtures thereof;
and S has the formula

J_{q}W
wherein:
   the index q is 0 or 1; and
   each J is independently selected from the group consisting of

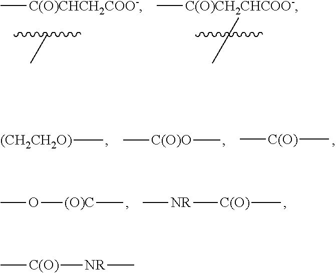

wherein R is hydrogen or methyl; and
when J=0 each W comprises one of the moieties selected from the group consisting of C₄- to C₂₆-alkyl, C₄- to C₂₆-alkenyl, C₄- to C₂₆-hydroxyalkyl, C₄- to C₂₆-hydroxyalkenyl, C₄- to C₂₆-alkylcarboxyl; C₄- to C₂₆-aryl, polyisobutylene, a silicone polymer, in one aspect, said silicone polymer comprises a polydimethylsiloxane, a silicone polyether, an aminosilicones and when J=leach W comprises one of the moieties selected from the group consisting of C₁- to C₂₆-alkyl, C₁- to C₂₆-alkenyl, C₁- to C₂₆-hydroxyalkyl, C₁- to C₂₆-hydroxyalkenyl, C₁- to C₂₆-alkylcarboxyl; C₁- to C₂₆-aryl, polyisobutylene, polypropylene, polypropylene oxide, propylene oxide, a silicone polymer, in one aspect, said silicone polymer comprises a polydimethylsiloxane, a silicone polyether, an aminosilicones; in one aspect, said aminosilicones have the formula:

[R₁R₂R₃SiO_{1/2}]₍ⱼ₊₂₎[R₄Si(X—K)O_{2/2}]ₖ[R₄R₄SiO_{2/2}]ₘ[R₄SiO_{3/2}]ⱼ
wherein:
   j is a number from 0 to about 98; in one aspect j is a number from 0 to about 48; in one aspect, j is 0;
   k k is an integer from 0 to about 200, in one aspect k is an integer from 0 to about 50; when k=0, at least one of R₁, R₂ or R₃ is —X—K;
   m is a number from 4 to about 5,000; in one aspect m is a number from about 10 to about 4,000; in another aspect m is a number from about 50 to about 2,000;
   R₁, R₂ and R₃ are each independently selected from the group consisting of H, OH, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, C₁-C₃₂ alkoxy, C₁-C₃₂ substituted alkoxy; a divalent alkylene radical comprising 2-12 carbon atoms, and X—K; with the proviso that when k=0, at least one of R₁, R₂ or R₃ is —X—K; and
   each R₄ is independently selected from the group consisting of H, OH, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, C₁-C₃₂ alkoxy, C₁-C₃₂ substituted alkoxy and a divalent alkylene radical comprising 2-12 carbon atoms; with the proviso that at least one but no more than five of said R₁, R₂, R₃ and R₄ moieties is a divalent alkylene radical comprising 2-12 carbon atoms; and
   for each X—K,
   X comprises a divalent alkylene radical comprising 2-12 carbon atoms, in one aspect, each of said divalent alkylene radical is independently selected from the group consisting of —(CH₂)ₙ— wherein s is an integer from about 2 to about 8, in one aspect s is an integer from about 2 to about 4;
   each K is selected independently from the group consisting of:

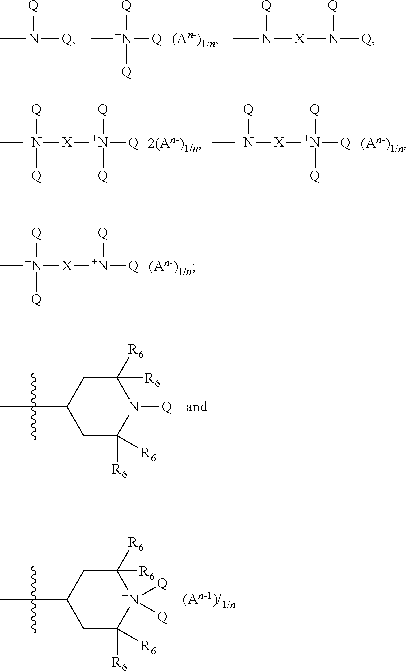

with the proviso that when K is quaternary, Q cannot be an amide, imine, or urea moiety and if Q is an amide, imine, or urea moiety, then any additional Q bonded to the same nitrogen as said amide, imine, or urea moiety must be H or a C₁-C₆ alkyl, in one aspect, said additional Q is H;
X is defined as above;
each index n, when present in K, is an integer from 1 to 4;
A is a suitable charge balancing anion. In one aspect A is selected from the group consisting of Cl⁻, Br⁻, I⁻, methylsulfate, toluene sulfonate, carboxylate and phosphate; and at least one Q in said organosilicone is independently selected from the group comprising of H, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, —CH₂—CH(OH)—CH₂—R₅;
wherein each R₅ is independently selected from the group consisting of H, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, —(CHR₆—CHR₆—O—)_{w}-L and a siloxyl residue;
each R₆ is independently selected from H, C₁-C₁₈ alkyl
each L is independently selected from —C(O)—R₇ or R₇; each R₇ is independently selected from the group consisting of H, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl and a siloxyl residue;
w is an integer from 0 to about 500, in one aspect w is an integer from about 1 to about 200; in one aspect w is an integer from about 1 to about 50;
c) the ratio of benefit agent to layering material being from about 5000:1 to about 1:1; from about 2500:1 to about 5:1, from about 1000:1 to about 5:1, from about 200:1 to about 5:1, from about 100:1 to about 10:1;
d) optionally, a surfactant selected from the group consisting of anionic surfactants, cationic surfactants, non-ionic surfactants, amphoteric surfactants and mixtures thereof; and
e) optionally, a second benefit agent selected from the group consisting of clays, metal oxides, silicones, microcapsules, nano-latex and mixtures thereof
   is disclosed.

In one aspect, of said particle, said first benefit agent comprises a material selected from the group consisting of a silicone, a vinyl polymer, a polyether, a material comprising a hydrocarbon wax, a hydrocarbon liquid, a fluid sugar polyester, a fluid sugar polyether, and mixtures thereof.

In one aspect, of said particle,
a) said silicone comprises an organosilicone;
b) said vinyl polymer is selected from group consisting of
   (i) hydrogenated or unhydrogenated polyisoprene;
   (ii) hydrogenated or unhydrogenated polyisoprene comprising one or more monomers selected from the group consisting of styrene, acrylonitrile, and acrylates;
   (iii) hydrogenated or unhydrogenated polyisobutylene;
   (iv) hydrogenated or unhydrogenated polyisobutylene comprising one or more monomers selected from the group consisting of styrene, acrylonitrile, and acrylates;
   (v) hydrogenated or unhydrogenated polybutadiene;
   (vi) hydrogenated or unhydrogenated polybutadiene comprising one or more monomers selected from the group consisting of styrene, acrylonitrile, and acrylates;
   (vii) hydrogenated or unhydrogenated copolymers comprising at least two or at least three materials selected from the group consisting of isoprene, polyisoprene comprising one or more monomers selected from the group consisting of styrene, acrylonitrile, and acrylates; isobutylene, polyisobutylene comprising one or more monomers selected from the group consisting of styrene, acrylonitrile, and acrylates, butadiene and polybutadiene comprising one or more monomers selected from the group consisting of styrene, acrylonitrile, and acrylates;
   (viii) acrylate polymer;
   (ix) methacrylate polymer;
   (x) acrylate copolymers comprising at least two or at least three different acrylate and/or methacrylate monomers;
   (xi) a modified polyisobutene compound that is uncharged or has a net charge selected from the group consisting of cationic or anionic;
c) said polyether comprises a material selected from the group consisting of ethylene oxide, propylene oxide, butylene oxide and mixtures thereof;
d) said material comprising a hydrocarbon wax comprises a material selected from the group consisting of a hydrocarbon liquid, silicone, and mixtures thereof;
e) said hydrocarbon liquid comprises one or more C₅ to C₁₀₀ alkanes;
f) said fluid sugar polyester comprises a cyclic polyol and/or reduced saccharide; in one aspect, from about 33 to about 100% of said cyclic polyol's and/or reduced saccharide's hydroxyl moieties are esterified; in one aspect, two or more of said ester moieties are independently attached to an alkyl or an alkenyl chain; in one aspect said alkyl or alkenyl chain can be derived from a fatty acid mixture comprising at least 50% by weight of said mixture tallow fatty acid and/or oleyl fatty acid; in one aspect, said fatty acid mixture comprises a mixture of tallow fatty acid and oleyl fatty acid in a weight ratio of tallow fatty acid:oleyl fatty acid of 10:90 to 90:10, or 25:75 to 75:25; in one aspect, said fatty acid mixture contains only tallow fatty acid and oleyl fatty acid;
g) said fluid sugar polyether comprises a cyclic polyol and/or reduced saccharide; in one aspect, from about 33 to about 100% of said cyclic polyol's and/or reduced saccharide's hydroxyl moieties are etherified; in one aspect, two or more of said ether moieties are independently attached to an alkyl or an alkenyl chain; in one aspect said alkyl or alkenyl chain can be derived from a fatty alcohol mixture comprising at least 50% by weight of said mixture tallow fatty alcohol and/or oleyl fatty alcohol; in one aspect, said fatty alcohol mixture comprises a mixture of tallow fatty alcohol and oleyl fatty alcohol in a weight ratio of tallow fatty acid:oleyl fatty alcohol of 10:90 to 90:10, or 25:75 to 75:25; in one aspect, said fatty alcohol mixture contains only tallow fatty alcohol and oleyl fatty alcohol.

In one aspect, of said particle,
a) said silicone has a weight average molecular weight from about 1000 Daltons to about 1,000,000 Daltons, from about 1500 Daltons to about 300,000 Daltons, from about 2000 Daltons to about 100,000 Daltons, or from about 3000 Daltons to about 40,000 Daltons;
b) said vinyl polymer has a weight average molecular weight from about 1000 Daltons to about 1,000,000 Daltons, from about 1500 Daltons to about 300,000 Daltons, from about 2000 Daltons to about 100,000 Daltons, or from about 3000 Daltons to about 40,000 Daltons; and
c) said polyether has a weight average molecular weight from about 1000 Daltons to about 1,000,000 Daltons, from about 1500 Daltons to about 300,000 Daltons, from about 2000 Daltons to about 100,000 Daltons, or from about 3000 Daltons to about 40,000 Daltons.

In one aspect, of said particle:
a) said silicone comprises an organosilicone;
b) said vinyl polymer is selected from group consisting of
   (i) hydrogenated or unhydrogenated polyisoprene;
   (ii) hydrogenated or unhydrogenated polyisoprene comprising one or more monomers selected from the group consisting of styrene, acrylonitrile, and acrylates;
   (iii) hydrogenated or unhydrogenated polyisobutylene;
   (iv) hydrogenated or unhydrogenated polyisobutylene comprising one or more monomers selected from the group consisting of styrene, acrylonitrile, and acrylates;
   (v) hydrogenated or unhydrogenated polybutadiene;
   (vi) hydrogenated or unhydrogenated polybutadiene comprising one or more monomers selected from the group consisting of styrene, acrylonitrile, and acrylates;
   (vii) hydrogenated or unhydrogenated copolymers comprising at least two or at least three materials selected from the group consisting of isoprene, polyisoprene comprising one or more monomers selected from the group consisting of styrene, acrylonitrile, and acrylates; isobutylene, polyisobutylene comprising one or more monomers selected from the group consisting of styrene, acrylonitrile, and acrylates, butadiene and polybutadiene comprising one or more monomers selected from the group consisting of styrene, acrylonitrile, and acrylates;
   (viii) acrylate polymer;
   (ix) methacrylate polymer;
   (x) acrylate copolymers comprising at least two or at least three different acrylate and/or methacrylate monomers;
   (xi) a modified polyisobutene compound that is uncharged or has a net charge selected from the group consisting of cationic or anionic;
c) said polyether comprises a material selected from the group consisting of ethylene oxide, propylene oxide, butylene oxide, and mixtures thereof.

In one aspect, of said particle:
a) said silicone comprises a material selected from the group consisting of a polydimethylsiloxane, an aminosilicone, a cationic silicone, a silicone polyether, a cyclic silicone, a silicone resin, a fluorinated silicone and mixtures thereof;
b) said vinyl polymer comprises a material selected from the group consisting of isoprene-isobutylene copolymer, carboxylated acrylonitrile butadiene copolymer, styrene-isoprene copolymer, styrene-butadiene block copolymers, and mixtures thereof;
c) said polyether comprises a material selected from the group consisting of polyethylene oxide, polypropylene oxide, poly alkyl oxirane, and mixtures thereof;
d) said material comprising a hydrocarbon wax comprises a material selected from petrolatum, microcrystalline wax, paraffin wax, Beeswax, Chinese wax, Lanolin, Spermaceti, Bayberry wax, Myrica faya, Candelilla wax, Carnauba wax, Copernica cerifera, Castor wax, Esparto wax, Japan wax, Jojoba oil, Simmondsia chinensis, Ouricury wax, Syagrus coronata. Rice bran wax, Soy wax, Ceresin waxes, Montan wax, Ozocerite, Peat waxes, Polyethylene waxes, Fischer-Tropsch waxes, amide substituted waxes, polymerized α-olefins, and mixtures thereof; and
e) said hydrocarbon liquid comprises a material selected from the group consisting of mineral oil, non-crystalline polymerized α-olefins, and mixtures thereof.

In one aspect, of said particle:
a) said polydimethylsiloxane has a viscosity from about 10 centistokes (cSt) to about 2,000,000 cSt; from about 50 cSt to about 1,000,000 cSt; from about 500 cSt to about 100,000 cSt; or from about 750 cSt to about 1000 cSt;
b) said aminosilicone has a viscosity from about 100 cSt to about 300,000 cSt; from about 500 cSt to about 200,000 cSt; from about 750 cSt to about 50,000 cSt; or from about 1000 cSt to about 5000 cSt;
c) said cationic silicone has a viscosity from about 100 cSt to about 1,000,000 cSt; from about 500 cSt to about 500,000 cSt; from about 750 cSt to about 50,000 cSt; or from about 1000 cSt to about 5000 cSt;
d) said silicone polyether has a viscosity from about 100 cSt to about 1,000,000 cSt; from about 500 cSt to about 500,000 cSt; from about 750 cSt to about 50,000 cSt; or from about 1000 cSt to about 5000 cSt;
e) said cyclic silicone has a viscosity from about 10 cSt to about 10,000 cSt; from about 50 cSt to about 5,000 cSt; from about 100 cSt to about 2,000 cSt; or from about 200 cSt to about 1000 cSt;
f) said silicone resin has a viscosity from about 10 cSt to about 10,000 cSt; from about 50 cSt to about 5,000 cSt; from about 100 cSt to about 2,000 cSt; or from about 200 cSt to about 1000 cSt; and
g) said fluorinated silicone has a viscosity from about 100 cSt to about 300,000 cSt; from about 500 cSt to about 200,000 cSt; from about 750 cSt to about 50,000 cSt; or from about 1000 cSt to about 5000 cSt.

In one aspect, of said particle, the silicone has the structure:

[R₁R₂R₃SiO_{1/2}]₍ⱼ₊₂₎[(R₄Si(X-Z)O_{2/2}]ₖ[R₄R₄SiO_{2/2}]ₘ[R₄SiO_{3/2}]ⱼ

wherein:
j is an integer from 0 to about 98; in one aspect j is an integer from 0 to about 48; in one aspect, j is 0;
k is an integer from 0 to about 200; in one aspect, k is an integer from 0 to about 50; when k=0, at least one of R₁, R₂ or R₃=—X-Z,
m is an integer from 4 to about 5,000; in one aspect m is an integer from about 10 to about 4,000; in another aspect m is an integer from about 50 to about 2,000;
R₁, R₂ and R₃ are each independently selected from the group consisting of H, OH, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, C₁-C₃₂ alkoxy, C₁-C₃₂ substituted alkoxy and X-Z;
each R₄ is independently selected from the group consisting of H, OH, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, C₁-C₃₂ alkoxy and C₁-C₃₂ substituted alkoxy;
for each X-Z,
   X comprises a divalent alkylene radical comprising 2-12 carbon atoms; and
   at least one Z in the said organosiloxane is selected from the group consisting of R₅;

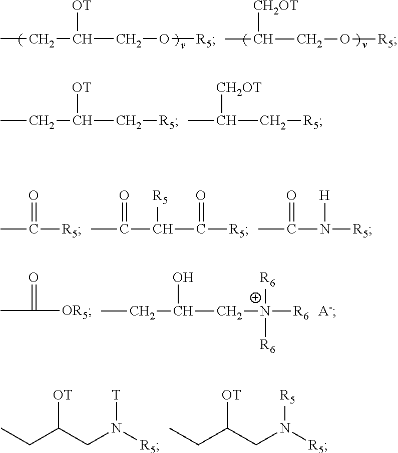

each additional Z in said organosilicone is independently selected from the group comprising of H, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, R₅,

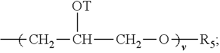

each R₅ is independently selected from the group consisting of H; C₁-C₃₂ alkyl; C₁-C₃₂ substituted alkyl, C₅-C₃₂ or C₆-C₃₂ aryl, C₅-C₃₂ or C₆-C₃₂ substituted aryl or C₆-C₃₂ alkylaryl, or C₆-C₃₂ substituted alkylaryl, —(CHR₆—CHR₆—O—)_{w}—CHR₆—CHR₆-L and a siloxyl residue;
   w is an integer from 0 to about 500, in one aspect w is an integer from 0 to about 200, one aspect w is an integer from 0 to about 50;
   each R₆ is independently selected from H or a C₁-C₁₈ alkyl;
   wherein each L is independently selected from

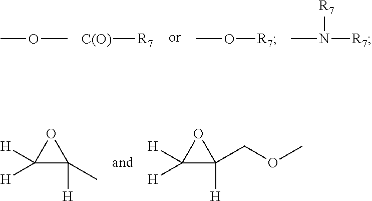

each R₇ is independently selected from the group consisting of H; C₁-C₃₂ alkyl; C₁-C₃₂ substituted alkyl, C₅-C₃₂ or C₆-C₃₂ aryl, C₅-C₃₂ or C₆-C₃₂ substituted aryl, C₆-C₃₂ alkylaryl, and C₆-C₃₂ substituted aryl, and a siloxyl residue;
each T is independently selected from H;

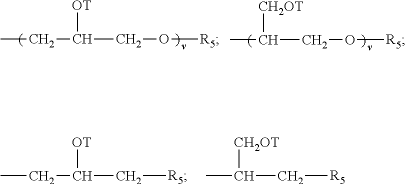

wherein each v in said organosilicone is an integer from 1 to about 10, in one aspect, v is an integer from 1 to about 5 and the sum of all v indices in each Z in the said organosilicone is an integer from 1 to about 30 or from 1 to about 20 or from 1 to about 10, with the proviso that the total moieties T in a molecule does not exceed 6.

In one aspect, of said particle, the organosilicone comprises a pendant aminosilicone and/or terminal aminosilicone.

In one aspect, of said particle, the pendant aminosilicone has the structure:

[R₁R₂R₃SiO_{1/2}]₍ⱼ₊₂₎[R₄Si(X—K)O_{2/2}]ₖ[R₄R₄SiO_{2/2}]ₘ[R₄SiO_{3/2}]ⱼ

wherein:
j is an integer from 0 to about 98; in one aspect j is an integer from 0 to about 48; in one aspect, j is 0;
k is an integer from 0 to about 200, in one aspect k is an integer from 0 to about 50; when k=0, at least one of R₁, R₂ or R₃ is —X—K;
m is an integer from 4 to about 5,000; in one aspect m is an integer from about 10 to about 4,000; in another aspect m is an integer from about 50 to about 2,000;
R₁, R₂ and R₃ are each independently selected from the group consisting of H, OH, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, C₁-C₃₂ alkoxy, C₁-C₃₂ substituted alkoxy and X—K;
each R₄ is independently selected from the group consisting of H, OH, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, C₁-C₃₂ alkoxy and C₁-C₃₂ substituted alkoxy; for each X—K
   X comprises a divalent alkylene radical comprising 2-12 carbon atoms, in one aspect, each divalent alkylene radical is independently selected from the group consisting of —(CH₂)ₛ— wherein s is an integer from 2 to 8, or an integer from 2 to 4; and
each K is selected independently from the group consisting of,

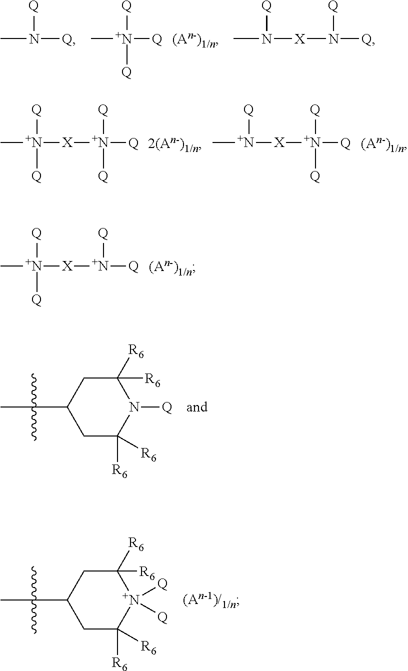

each Q is independently a H or a C₁-C₃₂, linear or branched, substituted or unsubstituted hydrocarbon, with the proviso that when K is a quat, Q cannot be an amide, imine, or urea moiety and if Q is an amide, imine, or urea moiety, then any additional Q bonded to the same nitrogen as said amide, imine, or urea moiety must be H or a C₁-C₆ alkyl, in one aspect, said additional Q is H;
X is defined as above;
   for K each index n, when present in K, is an integer from 1 to 4;
   A is a suitable charge balancing anion. In one aspect A is selected from the group consisting of Cl⁻, Br⁻, I⁻, methylsulfate, toluene sulfonate, carboxylate and phosphate; and at least one Q in said organosilicone is independently selected from

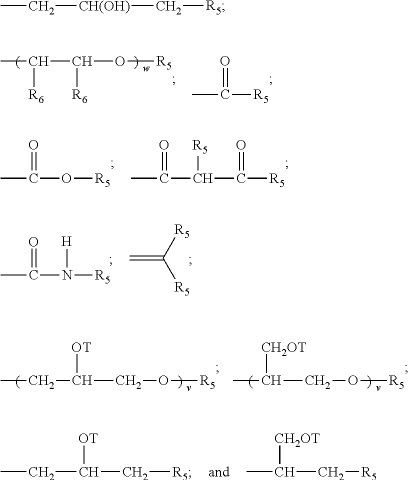

for cationically charged K, A is a suitable charge balancing anion, in one aspect A is selected from the group consisting of Cl—, Br—, I—, methylsulfate, toluene sulfonate, carboxylate and phosphate.
   wherein each R₅ is independently selected from the group consisting of H, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, —(CHR₆—CHR₆—O—)_{w}-L and a siloxyl residue;
each R₆ is independently selected from H, C₁-C₁₈ alkyl each L is independently selected from —C(O)—R₇ or R₇;
R₇ is independently selected from the group consisting of H, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl and a siloxyl residue;
w is an integer from 0 to about 500, in one aspect w is an integer from about 1 to about 200; in one aspect w is an integer from about 1 to about 50
each T is independently selected from H;

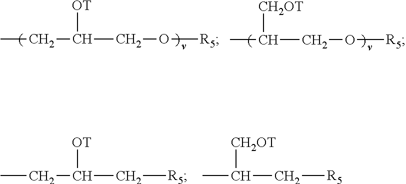

wherein each v in said organosilicone is an integer from 1 to about 10, in one aspect, v is an integer from 1 to about 5 and the sum of all v indices in each Z in the said organosilicone is an integer from 1 to about 30 or from 1 to about 20 or from 1 to about 10, with the proviso that the total moieties T in a molecule does not exceed 6.

In one aspect, of said particle, the pendant aminosilicone has a molecular weight from about 1000 Daltons to about 1000000 Daltons; from about 10000 Daltons to about 100000 Daltons; or from about 15000 Daltons to about 50000 Daltons.

In one aspect, of said particle, S comprises a residue of monomer selected from the group consisting of vinyl formamide, vinyl acetate, alkyl acrylates, alkyl methacrylates, styrene, substituted styrene, and mixtures thereof.

In one aspect, of said particle, P is a polyamine selected from the group consisting of linear poly(ethyleneimine), branched poly(ethyleneimine), linear poly(vinylamine), branched poly(vinylamine), linear poly(allylamine), branched poly(allylamine) and poly(amidoamine).

In one aspect, of said particle, the polyamine is a branched poly(ethyleneimine).

In one aspect, of said particle, said branched poly(ethyleneimine) has a number average molecular weight of from about 600 Daltons to about 750000 Daltons, from about 2000 Daltons to about 500000 Daltons, or from about 25000 Daltons to about 75000 Daltons.

In one aspect, of said particle, P is linear poly(vinylamine).

In one aspect, of said particle, said linear poly(vinylamine) has a weight average molecular weight from about 10,000 Daltons to about 360000 Daltons, from about 12000 Daltons to about 200000 Daltons, or from about 15000 Daltons to about 45000 Daltons.

In one aspect, of said particle:
a) P is a random copolymer comprising, based upon total copolymer weight:
   (i) from about 0 weight percent to about 80 weight percent, from about 5 weight percent to about 70 weight percent, or from about 10 weight percent to about 60 weight percent N-vinyl pyrrolidone;
   (ii) from about 0.01 weight percent to about 20 weight percent, from about 0.05 weight percent to about 15 weight percent, or from about 0.5 weight percent to about 10 weight percent glycidyl methacrylate;
   (iii) from about 5 weight percent to about 95 weight percent, from about 10 weight percent to about 90 weight percent, or from about 15 weight percent to about 70 weight percent diallyldimethylammonium chloride; and
   (iv) from about 5 weight percent to about 95 weight percent, from about 10 weight percent to about 90 weight percent, or from about 15 weight percent to about 70 weight percent acrylamide;
b) S is selected from the group consisting of:
   (i) C₆-C₅₀ alkyl, C₈-C₄₀ alkyl, C₁₀-C₂₄ alkyl, or C₁₂-C₁₈ alkyl;
   (ii) a material having the formula:

[R₁R₂R₃SiO_{1/2}]₍ⱼ₊₂₎[R₄Si(X—K)O_{2/2}]ₖ[R₄R₄SiO_{2/2}]ₘ[R₄SiO_{3/2}]ⱼ
wherein:
   j is a number from 0 to about 98; in one aspect j is a number from 0 to about 48; in one aspect, j is 0;
   k k is an integer from 0 to about 200, in one aspect k is an integer from 0 to about 50; when k=0, at least one of R₁, R₂ or R₃ is —X—K;
   m is a number from 4 to about 5,000; in one aspect m is a number from about 10 to about 4,000; in another aspect m is a number from about 50 to about 2,000;
   R₁, R₂ and R₃ are each independently selected from the group consisting of H, OH, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, C₁-C₃₂ alkoxy, C₁-C₃₂ substituted alkoxy, a divalent alkylene radical comprising 2-12 carbon atoms and X—K; with the proviso that when k=0, at least one of R₁, R₂ and R₃ is —X—K;
   each R₄ is independently selected from the group consisting of H,
   OH, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, C₁-C₃₂ alkoxy, C₁-C₃₂ substituted alkoxy and a divalent alkylene radical comprising 2-12 carbon atoms; with the proviso that at least one but no more than five of said R₁, R₂, R₃ and R₄ moieties is a divalent alkylene radical comprising 2-12 carbon atoms;
   for each X—K, X comprises a divalent alkylene radical comprising 2-12 carbon atoms, in one aspect each of said divalent alkylene radical is independently selected from the group consisting of —(CH₂)ₛ— wherein s is an integer from about 2 to about 8, in one aspect s is an integer from about 2 to about 4;
   each K is selected independently from the group consisting of

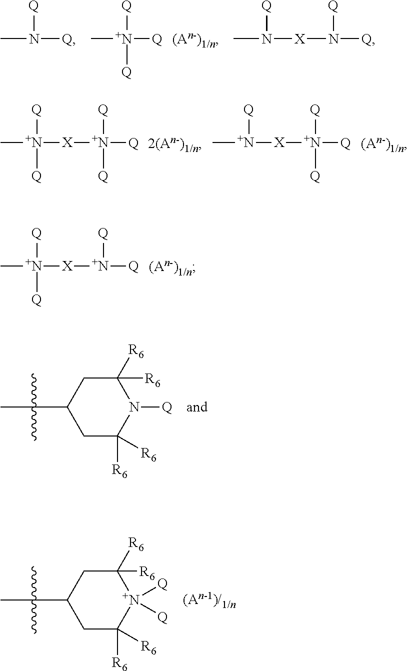

at least one Q in said organosilicone is independently selected from

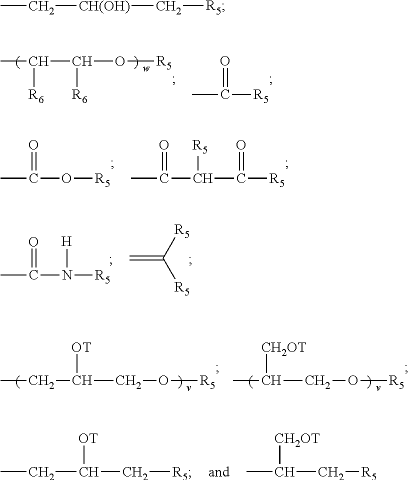

each additional Q in said organosilicone is independently selected from the group comprising of H, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, —CH₂—CH(OH)—CH₂—R₅;
wherein each R₅ is independently selected from the group consisting of H, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, —(CHR₆—CHR₆—O—)_{w}-L and a siloxyl residue;
each R₆ is independently selected from H, C₁-C₁₈ alkyl
each L is independently selected from —C(O)—R₇ or R₇;
R7 is independently selected from the group consisting of H, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl and a siloxyl residue;
w is an integer from 0 to about 500, in one aspect w is an integer from about 1 to about 200; in one aspect w is an integer from about 1 to about 50, with the proviso that when K is quaternary, Q cannot be an amide, imine, or urea moiety and if Q is an amide, imine, or urea moiety, then any additional Q bonded to the same nitrogen as said amide, imine, or urea moiety must be H or a C₁-C₆ alkyl, in one aspect, said additional Q is H;
X is defined as above;
for K each index n, when present in K, is an integer from 1 to 4; A is a suitable charge balancing anion. In one aspect A is selected from the group consisting of Cl⁻, Br⁻, I⁻, methylsulfate, toluene sulfonate, carboxylate and phosphate
each T is independently selected from H;

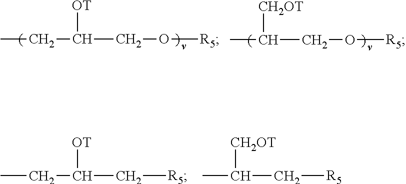

wherein each v in said organosilicone is an integer from 1 to about 10, in one aspect, v is an integer from 1 to about 5 and the sum of all v indices in each Z in the said organosilicone is an integer from 1 to about 30 or from 1 to about 20 or from 1 to about 10, with the proviso that the total moieties T in a molecule does not exceed 6.

In one aspect, a composition comprising any of the particles disclosed herein and an adjunct ingredient is disclosed.

In one aspect, said composition is a consumer product.

In one aspect, said composition is a liquid laundry detergent, liquid fabric enhancer, granule and/or powdered laundry detergent, hair conditioner, shampoo, body wash or leave on hair treatment. In one aspect, said compositions may be used for multiple purpose. For example, a body wash may be used as a shampoo.

In one aspect, a method of treating a situs comprising contacting a situs with any particle disclosed herein and/or any composition disclosed herein that comprising any such particle is disclosed.

In one aspect, a process comprising:
a) combining, in any order, a benefit agent, a deposition modifier, and optionally water while mixing, under high shear conditions, to form a mixture comprising said benefit agent, deposition modifier, and optionally water, said mixture being a fluid; in one aspect said step a) comprises heating from about 25° C. to about 150° C., from about 30° C. to about 125° C., or from about 50° C. to about 100° C.;
b) optionally, adding organic solvent to said mixture of benefit agent, deposition modifier, and optional water;
c) optionally, adjusting the pH of said mixture of benefit agent, deposition modifier, and optional water while mixing;
d) optionally, adding a surfactant to said mixture of benefit agent, deposition modifier, and optional water;
e) optionally, adding salt to said mixture of benefit agent, deposition modifier, and optional water; and
f) optionally, adding said combination to a liquid
   is disclosed.

### Composition Comprising Hydrophobically Modified Cationic Polymer and Use of Same

In one aspect, a composition comprising:
a) a hydrophobically modified cationic polymer, said hydrophobically modified cationic polymer having the formula:

PᵣSₓ
wherein r is a number from about 10 to about 10,000, and S is a hydrophobic moiety and the index x is a number from about 1 to a number that is equal to about r/10; and P is selected from the group consisting of:
(i) a polyamine, in one aspect, a polyethyleneimine;
(ii) a copolymer comprising acrylamide and a neutral, cationic, and/or anionic vinyl monomer;
(iii) a polyvinylformamide; in one aspect, said polyvinylformamide may be partially or fully hydrolyzed;
(iv) a copolymer comprising vinyl formamide and a neutral, cationic, and/or anionic vinyl monomer; in one aspect, said vinylformamide may be partially or fully hydrolyzed;
(v) a copolymer comprising vinylpyrrolidone and a neutral, cationic, and/or anionic vinyl monomer;
(vi) an amine-epichlorohydrin polymer; in one aspect, said amine-epichlorohydrin polymer may be chemically modified;
(vii) a copolymer comprising vinylimidazole and a neutral, cationic, and/or anionic vinyl monomer; in one aspect, said vinylimidazole is quaternized;
(viii) a copolymer comprising diallyldimethylammonium chloride and a neutral, cationic, and/or anionic vinyl monomer;
(ix) a copolymer comprising methacryloylpropyltrimethylammonium chloride and a neutral, cationic, and/or anionic vinyl monomer;
(x) a copolymer comprising acryloylpropyltrimethylammonium chloride and a neutral, cationic, and/or anionic vinyl monomer;
(xi) a copolymer comprising (3-methacrylamidopropyl)trimethylammonium chloride and a neutral, cationic, and/or anionic vinyl monomer; and
(xii) mixtures thereof;
and S has the formula

J_{q}W
wherein:
   the index q is 0 or 1; and
   each J is independently selected from the group consisting of

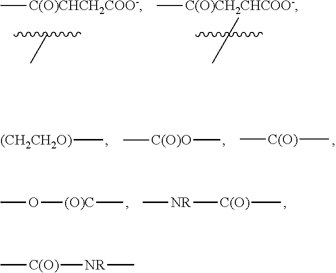

wherein R is hydrogen or methyl; and
when J=0 each W comprises one of the moieties selected from the group consisting of C₄- to C₂₆-alkyl, C₄- to C₂₆-alkenyl, C₄- to C₂₆-hydroxyalkyl, C₄- to C₂₆-hydroxyalkenyl, C₄- to C₂₆-alkylcarboxyl; C₄- to C₂₆-aryl, polyisobutylene, a silicone polymer, in one aspect, said silicone polymer comprises a polydimethylsiloxane, a silicone polyether, an aminosilicones and when J=leach W comprises one of the moieties selected from the group consisting of C₁- to C₂₆-alkyl, C₁- to C₂₆-alkenyl, C₁- to C₂₆-hydroxyalkyl, C₁- to C₂₆-hydroxyalkenyl, C₁- to C₂₆-alkylcarboxyl; C₁- to C₂₆-aryl, polyisobutylene, polypropylene, polypropylene oxide, propylene oxide, a silicone polymer, in one aspect, said silicone polymer comprises a polydimethylsiloxane, a silicone polyether, an aminosilicones; in one aspect, said aminosilicones have the formula:

[R₁R₂R₃SiO_{1/2}]₍ⱼ₊₂₎[R₄Si(X—K)O_{2/2}]ₖ[R₄R₄SiO_{2/2}]ₘ[R₄SiO_{3/2}]ⱼ
wherein:
   j is a number from 0 to about 98; in one aspect j is a number from 0 to about 48; in one aspect, j is 0;
   k k is an integer from 0 to about 200, in one aspect k is an integer from 0 to about 50; when k=0, at least one of R₁, R₂ or R₃ is —X—K;
   m is a number from 4 to about 5,000; in one aspect m is a number from about 10 to about 4,000; in another aspect m is a number from about 50 to about 2,000;
   R₁, R₂ and R₃ are each independently selected from the group consisting of H, OH, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, C₁-C₃₂ alkoxy, C₁-C₃₂ substituted alkoxy, a divalent alkylene radical comprising 2-12 carbon atoms and X—K; with the proviso that when k=0, at least one of R₁, R₂ or R₃ is —X—K; and
   each R₄ is independently selected from the group consisting of H, OH, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, C₁-C₃₂ alkoxy, C₁-C₃₂ substituted alkoxy and a divalent alkylene radical comprising 2-12 carbon atoms; and for each X—K,
   X comprises a divalent alkylene radical comprising 2-12 carbon atoms, in one aspect, each of said divalent alkylene radical is independently selected from the group consisting of —(CH₂)ₛ— wherein s is an integer from about 2 to about 8, in one aspect s is an integer from about 2 to about 4;
   each K is selected independently from the group consisting of:

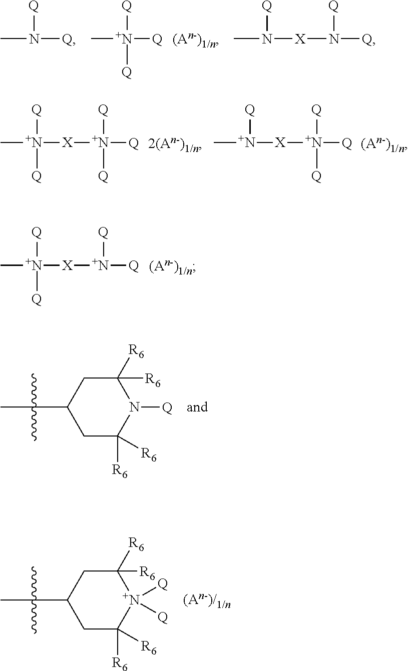

with the proviso that when K is quaternary, Q cannot be an amide, imine, or urea moiety and if Q is an amide, imine, or urea moiety, then any additional Q bonded to the same nitrogen as said amide, imine, or urea moiety must be H or a C₁-C₆ alkyl, in one aspect, said additional Q is H;
X is defined as above;
each index n, when present in K, is an integer from 1 to 4; A is a suitable charge balancing anion. In one aspect A is selected from the group consisting of Cl⁻, Br⁻, I⁻, methylsulfate, toluene sulfonate, carboxylate and phosphate; and at least one Q in said organosilicone is independently selected from the group comprising of H, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, —CH₂—CH(OH)—CH₂—R₅;
wherein each R₅ is independently selected from the group consisting of H, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, —(CHR₆—CHR₆—O—)_{w}-L and a siloxyl residue;
each R₆ is independently selected from H, C₁-C₁₈ alkyl
each L is independently selected from —C(O)—R₇ or R₇; each R₇ is independently selected from the group consisting of H, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl and a siloxyl residue;
w is an integer from 0 to about 500, in one aspect w is an integer from about 1 to about 200; in one aspect w is an integer from about 1 to about 50;
b) optionally, a first benefit agent;
c) optionally, a surfactant selected from the group consisting of anionic surfactants, cationic surfactants, non-ionic surfactants, amphoteric surfactants and mixtures thereof; and
d) optionally, a second benefit agent selected from the group consisting of clays, metal oxides, silicones, microcapsules, nano-latex and mixtures thereof
   is disclosed.

In one aspect, of said composition said composition comprises a first benefit agent; the ratio of said first benefit agent to hydrophobically modified cationic polymer being from about from about 40:1 to about 1:1; from about 40:1 to about 2:1; 40:1 to about 5:1; from about 35:1 to about 7:1, from about 30:1 to about 10:1, from about 20:1 to about 15:1.

In one aspect, of said composition said first benefit agent comprises a material selected from the group consisting of a silicone, a vinyl polymer, a polyether, a material comprising a hydrocarbon wax, a hydrocarbon liquid, a fluid sugar polyester, a fluid sugar polyether, and mixtures thereof.

In one aspect, of said composition:
a) said silicone comprises an organosilicone;
b) said vinyl polymer is selected from group consisting of
   (i) hydrogenated or unhydrogenated polyisoprene;
   (ii) hydrogenated or unhydrogenated polyisoprene comprising one or more monomers selected from the group consisting of styrene, acrylonitrile, and acrylates;
   (iii) hydrogenated or unhydrogenated polyisobutylene;
   (iv) hydrogenated or unhydrogenated polyisobutylene comprising one or more monomers selected from the group consisting of styrene, acrylonitrile, and acrylates;
   (v) hydrogenated or unhydrogenated polybutadiene;
   (vi) hydrogenated or unhydrogenated polybutadiene comprising one or more monomers selected from the group consisting of styrene, acrylonitrile, and acrylates;
   (vii) hydrogenated or unhydrogenated copolymers comprising at least two or at least three materials selected from the group consisting of isoprene, polyisoprene comprising one or more monomers selected from the group consisting of styrene, acrylonitrile, and acrylates; isobutylene, polyisobutylene comprising one or more monomers selected from the group consisting of styrene, acrylonitrile, and acrylates, butadiene and polybutadiene comprising one or more monomers selected from the group consisting of styrene, acrylonitrile, and acrylates;
   (viii) acrylate polymer;
   (ix) methacrylate polymer;
   (x) acrylate copolymers comprising at least two or at least three different acrylate and/or methacrylate monomers;
   (xi) a modified polyisobutene compound that is uncharged or has a net charge selected from the group consisting of cationic or anionic;
c) said polyether comprises a material selected from the group consisting of ethylene oxide, propylene oxide, butylene oxide and mixtures thereof;
d) said material comprising a hydrocarbon wax comprises a material selected from the group consisting of a hydrocarbon liquid, silicone, and mixtures thereof;
e) said hydrocarbon liquid comprises one or more C₅ to C₁₀₀ alkanes;
f) said fluid sugar polyester comprises a cyclic polyol and/or reduced saccharide; in one aspect, from about 33 to about 100% of said cyclic polyol's and/or reduced saccharide's hydroxyl moieties are esterified; in one aspect, two or more of said ester moieties are independently attached to an alkyl or an alkenyl chain; in one aspect said alkyl or alkenyl chain can be derived from a fatty acid mixture comprising at least 50% by weight of said mixture tallow fatty acid and/or oleyl fatty acid; in one aspect, said fatty acid mixture comprises a mixture of tallow fatty acid and oleyl fatty acid in a weight ratio of tallow fatty acid:oleyl fatty acid of 10:90 to 90:10, or 25:75 to 75:25; in one aspect, said fatty acid mixture contains only tallow fatty acid and oleyl fatty acid; and
g) said fluid sugar polyether comprises a cyclic polyol and/or reduced saccharide; in one aspect, from about 33 to about 100% of said cyclic polyol's and/or reduced saccharide's hydroxyl moieties are etherified; in one aspect, two or more of said ether moieties are independently attached to an alkyl or an alkenyl chain; in one aspect said alkyl or alkenyl chain can be derived from a fatty alcohol mixture comprising at least 50% by weight of said mixture tallow fatty alcohol and/or oleyl fatty alcohol; in one aspect, said fatty alcohol mixture comprises a mixture of tallow fatty alcohol and oleyl fatty alcohol in a weight ratio of tallow fatty acid:oleyl fatty alcohol of 10:90 to 90:10, or 25:75 to 75:25; in one aspect, said fatty alcohol mixture contains only tallow fatty alcohol and oleyl fatty alcohol.

In one aspect, of said composition:
a) said silicone has a weight average molecular weight from about 1000 Daltons to about 1,000,000 Daltons, from about 1500 Daltons to about 300,000 Daltons, from about 2000 Daltons to about 100,000 Daltons, or from about 3000 Daltons to about 40,000 Daltons;
b) said vinyl polymer has a weight average molecular weight from about 1000

Daltons to about 1,000,000 Daltons, from about 1500 Daltons to about 300,000 Daltons, from about 2000 Daltons to about 100,000 Daltons, or from about 3000 Daltons to about 40,000 Daltons; and
c) said polyether has a weight average molecular weight from about 1000 Daltons to about 1,000,000 Daltons, from about 1500 Daltons to about 300,000 Daltons, from about 2000 Daltons to about 100,000 Daltons, or from about 3000 Daltons to about 40,000 Daltons.
   In one aspect, of said composition:
a) said silicone comprises an organosilicone;
b) said vinyl polymer is selected from group consisting of:
   (i) hydrogenated or unhydrogenated polyisoprene;
   (ii) hydrogenated or unhydrogenated polyisoprene comprising one or more monomers selected from the group consisting of styrene, acrylonitrile, and acrylates;
   (iii) hydrogenated or unhydrogenated polyisobutylene;
   (iv) hydrogenated or unhydrogenated polyisobutylene comprising one or more monomers selected from the group consisting of styrene, acrylonitrile, and acrylates;
   (v) hydrogenated or unhydrogenated polybutadiene;
   (vi) hydrogenated or unhydrogenated polybutadiene comprising one or more monomers selected from the group consisting of styrene, acrylonitrile, and acrylates;
   (vii) hydrogenated or unhydrogenated copolymers comprising at least two or at least three materials selected from the group consisting of isoprene, polyisoprene comprising one or more monomers selected from the group consisting of styrene, acrylonitrile, and acrylates; isobutylene, polyisobutylene comprising one or more monomers selected from the group consisting of styrene, acrylonitrile, and acrylates, butadiene and polybutadiene comprising one or more monomers selected from the group consisting of styrene, acrylonitrile, and acrylates;
   (viii) acrylate polymer;
   (ix) methacrylate polymer;
   (x) acrylate copolymers comprising at least two or at least three different acrylate and/or methacrylate monomers;
   (xi) a modified polyisobutene compound that is uncharged or has a net charge selected from the group consisting of cationic or anionic;
c) said polyether comprises a material selected from the group consisting of ethylene oxide, propylene oxide, butylene oxide, and mixtures thereof.

In one aspect, of said composition:
a) said silicone comprises a material selected from the group consisting of a polydimethylsiloxane, an aminosilicone, a cationic silicone, a silicone polyether, a cyclic silicone, a silicone resin, a fluorinated silicone and mixtures thereof;
b) said vinyl polymer comprises a material selected from the group consisting of isoprene-isobutylene copolymer, carboxylated acrylonitrile butadiene copolymer, styrene-isoprene copolymer, styrene-butadiene block copolymers, and mixtures thereof;
c) said polyether comprises a material selected from the group consisting of polyethylene oxide, polypropylene oxide, poly alkyl oxirane, and mixtures thereof;
d) said material comprising a hydrocarbon wax comprises a material selected from petrolatum, microcrystalline wax, paraffin wax, Beeswax, Chinese wax, Lanolin, Spermaceti, Bayberry wax, Myrica faya, Candelilla wax, Carnauba wax, Copernica cerifera, Castor wax, Esparto wax, Japan wax, Jojoba oil, Simmondsia chinensis, Ouricury wax, Syagrus coronata. Rice bran wax, Soy wax, Ceresin waxes, Montan wax, Ozocerite, Peat waxes, Polyethylene waxes, Fischer-Tropsch waxes, amide substituted waxes, polymerized α-olefins, and mixtures thereof; and
e) said hydrocarbon liquid comprises a material selected from the group consisting of mineral oil, non-crystalline polymerized α-olefins, and mixtures thereof.

In one aspect, of said composition:
a) said polydimethylsiloxane has a viscosity from about 10 centistokes (cSt) to about 2,000,000 cSt; from about 50 cSt to about 1,000,000 cSt; from about 500 cSt to about 100,000 cSt; or from about 750 cSt to about 1000 cSt;
b) said aminosilicone has a viscosity from about 100 cSt to about 300,000 cSt; from about 500 cSt to about 200,000 cSt; from about 750 cSt to about 50,000 cSt; or from about 1000 cSt to about 5000 cSt;
c) said cationic silicone has a viscosity from about 100 cSt to about 1,000,000 cSt; from about 500 cSt to about 500,000 cSt; from about 750 cSt to about 50,000 cSt; or from about 1000 cSt to about 5000 cSt;
d) said silicone polyether has a viscosity from about 100 cSt to about 1,000,000 cSt; from about 500 cSt to about 500,000 cSt; from about 750 cSt to about 50,000 cSt; or from about 1000 cSt to about 5000 cSt;
e) said cyclic silicone has a viscosity from about 10 cSt to about 10,000 cSt; from about 50 cSt to about 5,000 cSt; from about 100 cSt to about 2,000 cSt; or from about 200 cSt to about 1000 cSt;
f) said silicone resin has a viscosity from about 10 cSt to about 10,000 cSt; from about 50 cSt to about 5,000 cSt; from about 100 cSt to about 2,000 cSt; or from about 200 cSt to about 1000 cSt; and
g) said fluorinated silicone has a viscosity from about 100 cSt to about 300,000 cSt; from about 500 cSt to about 200,000 cSt; from about 750 cSt to about 50,000 cSt; or from about 1000 cSt to about 5000 cSt.

In one aspect, of said composition said silicone has the structure:

[R₁R₂R₃SiO_{1/2}]₍ⱼ₊₂₎[R₄Si(X-Z)O_{2/2}]ₖ[R₄R₄SiO_{2/2}]ₘ[R₄SiO_{3/2}]ⱼ

wherein:
j is an integer from 0 to about 98; in one aspect j is an integer from 0 to about 48; in one aspect, j is 0;
k is an integer from 0 to about 200; in one aspect, k is an integer from 0 to about 50; when k=0, at least one of R₁, R₂ or R₃=—X-Z,
m is an integer from 4 to about 5,000; in one aspect m is an integer from about 10 to about 4,000; in another aspect m is an integer from about 50 to about 2,000;
R₁, R₂ and R₃ are each independently selected from the group consisting of H, OH, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, C₁-C₃₂ alkoxy, C₁-C₃₂ substituted alkoxy and X-Z;
each R₄ is independently selected from the group consisting of H, OH, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, C₁-C₃₂ alkoxy and C₁-C₃₂ substituted alkoxy; for each X-Z,
   X comprises a divalent alkylene radical comprising 2-12 carbon atoms; and
   at least one Z in the said organosiloxane is selected from the group consisting of R₅;

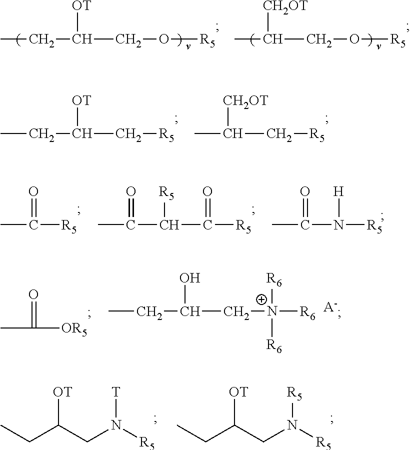

each additional Z in said organosilicone is independently selected from the group comprising of H, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, R₅,

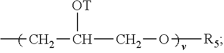

each R₅ is independently selected from the group consisting of H; C₁-C₃₂ alkyl; C₁-C₃₂ substituted alkyl, C₅-C₃₂ or C₆-C₃₂ aryl, C₅-C₃₂ or C₆-C₃₂ substituted aryl or C₆-C₃₂ alkylaryl, or C₆-C₃₂ substituted alkylaryl, —(CHR₆—CHR₆—O—)_{w}—CHR₆—CHR₆-L and a siloxyl residue;
   w is an integer from 0 to about 500, in one aspect w is an integer from 0 to about 200, one aspect w is an integer from 0 to about 50;
   each R₆ is independently selected from H or a C₁-C₁₈ alkyl;
   wherein each L is independently selected from

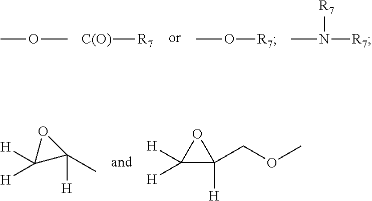

each R₇ is independently selected from the group consisting of H; C₁-C₃₂ alkyl; C₁-C₃₂ substituted alkyl, C₅-C₃₂ or C₆-C₃₂ aryl, C₅-C₃₂ or C₆-C₃₂ substituted aryl, C₆-C₃₂ alkylaryl, and C₆-C₃₂ substituted aryl, and a siloxyl residue;
each T is independently selected from H;

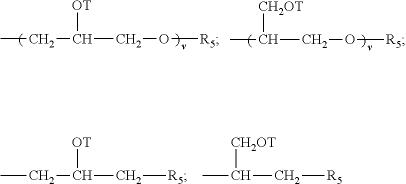

wherein each v in said organosilicone is an integer from 1 to about 10, in one aspect, v is an integer from 1 to about 5 and the sum of all v indices in each Z in the said organosilicone is an integer from 1 to about 30 or from 1 to about 20 or from 1 to about 10, with the proviso that the total moieties T in a molecule does not exceed 6.

In one aspect, of said composition said organosilicone comprises a pendant aminosilicone and/or terminal aminosilicone.

In one aspect, of said composition said pendant aminosilicone has the structure:

[R₁R₂R₃SiO_{1/2}]₍ⱼ₊₂₎[(R₄Si(X—K)O_{2/2}]ₖ[R₄R₄SiO_{2/2}]ₘ[R₄SiO_{3/2}]ⱼ
wherein:
   j is an integer from 0 to about 98; in one aspect j is an integer from 0 to about 48; in one aspect, j is 0;
   k is an integer from 0 to about 200, in one aspect k is an integer from 0 to about 50; when k=0, at least one of R₁, R₂ or R₃ is —X—K;
   m is an integer from 4 to about 5,000; in one aspect m is an integer from about 10 to about 4,000; in another aspect m is an integer from about 50 to about 2,000;
   R₁, R₂ and R₃ are each independently selected from the group consisting of H, OH, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, C₁-C₃₂ alkoxy, C₁-C₃₂ substituted alkoxy and X—K;
   each R₄ is independently selected from the group consisting of H, OH, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, C₁-C₃₂ alkoxy and C₁-C₃₂ substituted alkoxy; for each X—K X comprises a divalent alkylene radical comprising 2-12 carbon atoms, in one aspect, each divalent alkylene radical is independently selected from the group consisting of —(CH₂)ₛ— wherein s is an integer from 2 to 8, or an integer from 2 to 4; and
   each K is selected independently from the group consisting of,

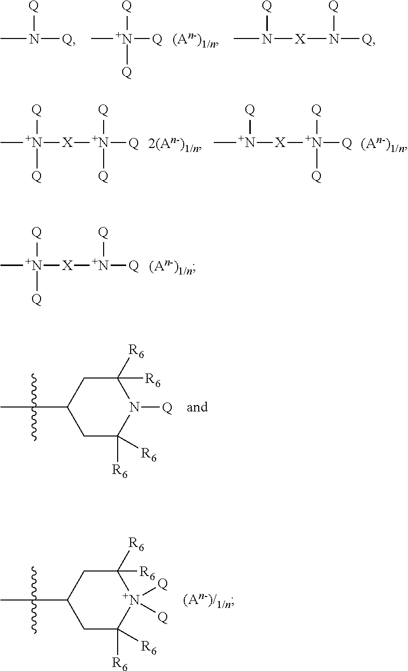

each Q is independently a H or a C₁-C₃₂, linear or branched, substituted or unsubstituted hydrocarbon, with the proviso that when K is a quat, Q cannot be an amide, imine, or urea moiety and if Q is an amide, imine, or urea moiety, then any additional Q bonded to the same nitrogen as said amide, imine, or urea moiety must be H or a C₁-C₆ alkyl, in one aspect, said additional Q is H;
X is defined as above;
for K Aⁿ⁻ is a suitable charge balancing anion. In one aspect Aⁿ⁻ is selected from the group consisting of Cl⁻, Br⁻, I⁻, methylsulfate, toluene sulfonate, carboxylate and phosphate; and at least one Q in said organosilicone is independently selected from

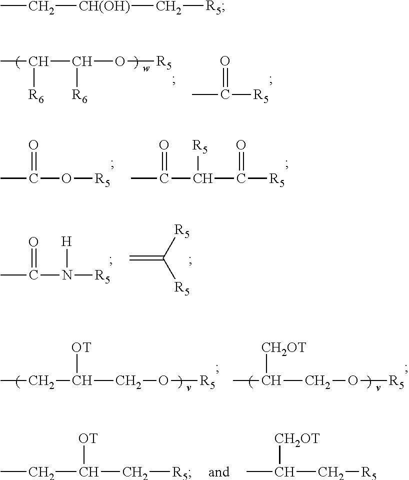

for cationically charged K, Aⁿ⁻ is a suitable charge balancing anion, in one aspect Aⁿ⁻ is selected from the group consisting of Cl—, Br—, I—, methylsulfate, toluene sulfonate, carboxylate and phosphate.
   wherein each R₅ is independently selected from the group consisting of H, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, —(CHR₆—CHR₆—O—)_{w}-L and a siloxyl residue;
   each R₆ is independently selected from H, C₁-C₁₈ alkyl each L is independently selected from —C(O)—R₇ or R₇;
   R₇ is independently selected from the group consisting of H, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl and a siloxyl residue;
   w is an integer from 0 to about 500, in one aspect w is an integer from about 1 to about 200; in one aspect w is an integer from about 1 to about 50 each T is independently selected from H;

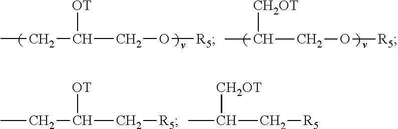

wherein each v in said organosilicone is an integer from 1 to about 10, in one aspect, v is an integer from 1 to about 5 and the sum of all v indices in each Z in the said organosilicone is an integer from 1 to about 30 or from 1 to about 20 or from 1 to about 10, with the proviso that the total moieties T in a molecule does not exceed 6.

In one aspect, of said composition said pendant aminosilicone has a molecular weight from about 1000 Daltons to about 1000000 Daltons; from about 10000 Daltons to about 100000 Daltons; or from about 15000 Daltons to about 50000 Daltons.

In one aspect, of said composition S comprises a monomer selected from the group consisting of vinyl formamide, vinyl acetate, alkyl acrylates, alkyl methacrylates, styrene, substituted styrene, and mixtures thereof.

In one aspect, of said composition P is a polyamine selected from the group consisting of linear poly(ethyleneimine), branched poly(ethyleneimine), linear poly(vinylamine), branched poly(vinylamine), linear poly(allylamine), branched poly(allylamine) and poly(amidoamine).

In one aspect, of said composition said polyamine is a branched poly(ethyleneimine).

In one aspect, of said composition said branched poly(ethyleneimine) has a number average molecular weight of from about 600 Daltons to about 750000 Daltons, from about 2000 Daltons to about 500000 Daltons, or from about 25000 Daltons to about 75000 Daltons.

In one aspect, of said composition P is linear poly(vinylamine).

In one aspect, of said composition said linear poly(vinylamine) has a weight average molecular weight from about 10,000 Daltons to about 360000 Daltons, from about 12000 Daltons to about 200000 Daltons, or from about 15000 Daltons to about 45000 Daltons.

In one aspect, of said composition:
a) P is a random copolymer comprising, based upon total copolymer weight:
   (i) from about 0 weight percent to about 80 weight percent, from about 5 weight percent to about 70 weight percent, or from about 10 weight percent to about 60 weight percent N-vinyl pyrrolidone;
   (ii) from about 0.01 weight percent to about 20 weight percent, from about 0.05 weight percent to about 15 weight percent, or from about 0.5 weight percent to about 10 weight percent glycidyl methacrylate;
   (iii) from about 5 weight percent to about 95 weight percent, from about 10 weight percent to about 90 weight percent, or from about 15 weight percent to about 70 weight percent diallyldimethylammonium chloride; and
   (iv) from about 5 weight percent to about 95 weight percent, from about 10 weight percent to about 90 weight percent, or from about 15 weight percent to about 70 weight percent acrylamide;
b) S is selected from the group consisting of:
   (i) C₆-C₅₀ alkyl, C₈-C₄₀ alkyl, C₁₀-C₂₄ alkyl, or C₁₂-C₁₈ alkyl;
   (ii) a material having the formula:

[R₁R₂R₃SiO_{1/2}]₍ⱼ₊₂₎[R₄Si(X—K)O_{2/2}]ₖ[R₄R₄SiO_{2/2}]ₘ[R₄SiO_{3/2}]ⱼ
wherein:
   j is a number from 0 to about 98; in one aspect j is a number from 0 to about 48; in one aspect, j is 0;
   k k is an integer from 0 to about 200, in one aspect k is an integer from 0 to about 50; when k=0, at least one of R₁, R₂ or R₃ is —X—K;
   m is a number from 4 to about 5,000; in one aspect m is a number from about 10 to about 4,000; in another aspect m is a number from about 50 to about 2,000;
   R₁, R₂ and R₃ are each independently selected from the group consisting of H, OH, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, C₁-C₃₂ alkoxy, C₁-C₃₂ substituted alkoxy, a divalent alkylene radical comprising 2-12 carbon atoms and X—K; with the proviso that when k=0, at least one of R₁, R₂ and R₃ is —X—K;
   each R₄ is independently selected from the group consisting of H, OH, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, C₁-C₃₂ alkoxy, C₁-C₃₂ substituted alkoxy and a divalent alkylene radical comprising 2-12 carbon atoms;
   with the proviso that at least one but no more than five of said R₁, R₂, R₃ and R₄ moieties is a divalent alkylene radical comprising 2-12 carbon atoms;
   for each X—K, X comprises a divalent alkylene radical comprising 2-12 carbon atoms, in one aspect each of said divalent alkylene radical is independently selected from the group consisting of —(CH₂)ₛ— wherein s is an integer from about 2 to about 8, in one aspect s is an integer from about 2 to about 4;
   each K is selected independently from the group consisting of

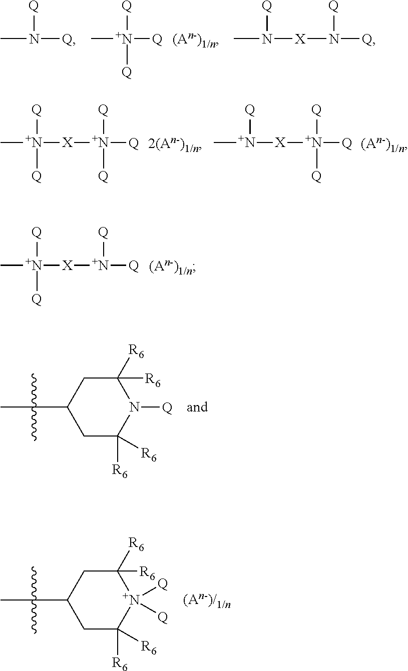

at least one Q in said organosilicone is independently selected from

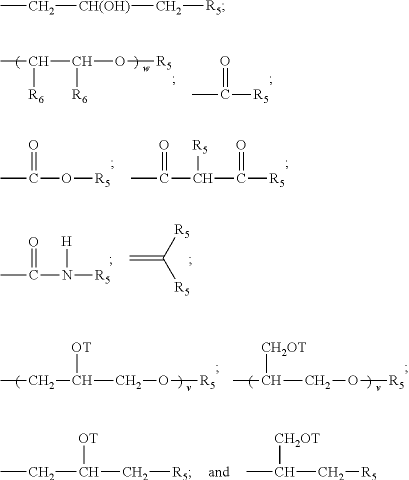

each additional Q in said organosilicone is independently selected from the group comprising of H, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, —CH₂—CH(OH)—CH₂—R₅;
wherein each R₅ is independently selected from the group consisting of H, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, —(CHR₆—CHR₆—O—)_{w}-L and a siloxyl residue;
each R₆ is independently selected from H, C₁-C₁₈ alkyl
each L is independently selected from —C(O)—R₇ or R₇;
R7 is independently selected from the group consisting of H, C1-C32 alkyl, C1-C32 substituted alkyl, C5-C32 or C6-C32 aryl, C5-C32 or C6-C32 substituted aryl, C6-C32 alkylaryl, C6-C32 substituted alkylaryl and a siloxyl residue;
w is an integer from 0 to about 500, in one aspect w is an integer from about 1 to about 200; in one aspect w is an integer from about 1 to about 50, with the proviso that when K is quaternary, Q cannot be an amide, imine, or urea moiety and if Q is an amide, imine, or urea moiety, then any additional Q bonded to the same nitrogen as said amide, imine, or urea moiety must be H or a C₁-C₆ alkyl, in one aspect, said additional Q is H;
X is defined as above;
for K each index n, when present in K, is an integer from 1 to 4; A is a suitable charge balancing anion. In one aspect A is selected from the group consisting of Cl⁻, Br⁻, I⁻, methylsulfate, toluene sulfonate, carboxylate and phosphate
each T is independently selected from H;

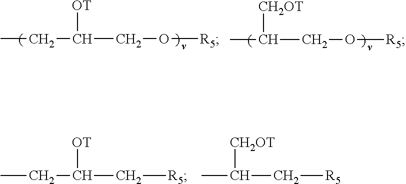

wherein each v in said organosilicone is an integer from 1 to about 10, in one aspect, v is an integer from 1 to about 5 and the sum of all v indices in each Z in the said organosilicone is an integer from 1 to about 30 or from 1 to about 20 or from 1 to about 10, with the proviso that the total moieties T in a molecule does not exceed 6.

In one aspect, said composition is a consumer product.

In one aspect, said composition is a liquid laundry detergent, liquid fabric enhancer, granule and/or powdered laundry detergent, hair conditioner, shampoo, body wash or leave on hair treatment. In one aspect, said compositions may be used for multiple purpose. For example, a body wash may be used as a shampoo.

In one aspect, a method of treating a situs comprising contacting a situs with any composition comprising said hydrophobically modified cationic polymer disclosed herein is disclosed.

### Additional Additives

Those of ordinary skill in the art will recognize that additional additives are optional but are often used in compositions of the type disclosed herein, for example fluid fabric enhancers. Thus such compositions may comprise an additional additive comprising: ingredients selected from the group comprising, additional softener actives, silicone compounds, structurants, deposition aids, perfumes, benefit agent delivery systems, dispersing agents, stabilizers, pH control agents, colorants, brighteners, dyes, fabric hueing agents odor control agent, solvents, soil release polymers, preservatives, antimicrobial agents, chlorine scavengers, anti-shrinkage agents, fabric crisping agents, spotting agents, anti-oxidants, anti-corrosion agents, bodying agents, drape and form control agents, smoothness agents, static control agents, wrinkle control agents, sanitization agents, disinfecting agents, germ control agents, mold control agents, mildew control agents, antiviral agents, anti-microbials, drying agents, stain resistance agents, soil release agents, malodor control agents, fabric refreshing agents, chlorine bleach odor control agents, dye fixatives, dye transfer inhibitors, color maintenance agents, color restoration/rejuvenation agents, anti-fading agents, whiteness enhancers, anti-abrasion agents, wear resistance agents, fabric integrity agents, anti-wear agents, defoamers and anti-foaming agents, rinse aids, UV protection agents, sun fade inhibitors, insect repellents, anti-allergenic agents, enzymes, flame retardants, water proofing agents, fabric comfort agents, water conditioning agents, shrinkage resistance agents, stretch resistance agents, thickeners, chelants, electrolytes and mixtures thereof. Such additives are known and can be included in the present formulation as needed. In one aspect, the fabric enhancer is free or substantially free of any of the aforementioned additives.

Fabric Hueing Agents—The composition may comprise a fabric hueing agent (sometimes referred to as shading, bluing or whitening agents). Typically the hueing agent provides a blue or violet shade to fabric. Hueing agents can be used either alone or in combination to create a specific shade of hueing and/or to shade different fabric types. This may be provided for example by mixing a red and green-blue dye to yield a blue or violet shade. Hueing agents may be selected from any known chemical class of dye, including but not limited to acridine, anthraquinone (including polycyclic quinones), azine, azo (e.g., monoazo, disazo, trisazo, tetrakisazo, polyazo), including premetallized azo, benzodifurane and benzodifuranone, carotenoid, coumarin, cyanine, diazahemicyanine, diphenylmethane, formazan, hemicyanine, indigoids, methane, naphthalimides, naphthoquinone, nitro and nitroso, oxazine, phthalocyanine, pyrazoles, stilbene, styryl, triarylmethane, triphenylmethane, xanthenes and mixtures thereof. Suitable fabric hueing agents include dyes, dye-clay conjugates, and organic and inorganic pigments. Suitable dyes include small molecule dyes and polymeric dyes. Suitable small molecule dyes include small molecule dyes selected from the group consisting of dyes falling into the Colour Index (C.I.) classifications of Acid, Direct, Basic, Reactive or hydrolysed Reactive, Solvent or Disperse dyes for example that are classified as Blue, Violet, Red, Green or Black, and provide the desired shade either alone or in combination. In another aspect, suitable small molecule dyes include small molecule dyes selected from the group consisting of Colour Index (Society of Dyers and Colourists, Bradford, UK) numbers Direct Violet dyes such as 9, 35, 48, 51, 66, and 99, Direct Blue dyes such as 1, 71, 80 and 279, Acid Red dyes such as 17, 73, 52, 88 and 150, Acid Violet dyes such as 15, 17, 24, 43, 49 and 50, Acid Blue dyes such as 15, 17, 25, 29, 40, 45, 75, 80, 83, 90 and 113, Acid Black dyes such as 1, Basic Violet dyes such as 1, 3, 4, 10 and 35, Basic Blue dyes such as 3, 16, 22, 47, 66, 75 and 159, Disperse or Solvent dyes such as those described in US 2008/034511 A1 or U.S. Pat. No. 8,268,016 B2, or dyes as disclosed in U.S. Pat. No. 7,208,459 B2, and mixtures thereof. In another aspect, suitable small molecule dyes include small molecule dyes selected from the group consisting of C. I. numbers Acid Violet 17, Acid Blue 80, Acid Violet 50, Direct Blue 71, Direct Violet 51, Direct Blue 1, Acid Red 88, Acid Red 150, Acid Blue 29, Acid Blue 113 or mixtures thereof.

Suitable polymeric dyes include polymeric dyes selected from the group consisting of polymers containing covalently bound (sometimes referred to as conjugated) chromogens, (dye-polymer conjugates), for example polymers with chromogens co-polymerized into the backbone of the polymer and mixtures thereof.

In another aspect, suitable polymeric dyes include polymeric dyes selected from the group consisting of fabric-substantive colorants sold under the name of Liquitint® (Milliken, Spartanburg, S.C., USA), dye-polymer conjugates formed from at least one reactive dye and a polymer selected from the group consisting of polymers comprising a moiety selected from the group consisting of a hydroxyl moiety, a primary amine moiety, a secondary amine moiety, a thiol moiety and mixtures thereof. In still another aspect, suitable polymeric dyes include polymeric dyes selected from the group consisting of Liquitint® Violet CT, carboxymethyl cellulose (CMC) covalently bound to a reactive blue, reactive violet or reactive red dye such as CMC conjugated with C.I. Reactive Blue 19, sold by Megazyme, Wicklow, Ireland under the product name AZO-CM-CELLULOSE, product code S-ACMC, alkoxylated triphenyl-methane polymeric colourants, alkoxylated thiophene polymeric colourants, and mixtures thereof.

The hueing agent may be incorporated into the detergent composition as part of a reaction mixture which is the result of the organic synthesis for a dye molecule, with optional purification step(s). Such reaction mixtures generally comprise the dye molecule itself and in addition may comprise un-reacted starting materials and/or by-products of the organic synthesis route.

Suitable pigments include pigments selected from the group consisting of flavanthrone, indanthrone, chlorinated indanthrone containing from 1 to 4 chlorine atoms, pyranthrone, dichloropyranthrone, monobromodichloropyranthrone, dibromodichloropyranthrone, tetrabromopyranthrone, perylene-3,4,9,10-tetracarboxylic acid diimide, wherein the imide groups may be unsubstituted or substituted by C1-C3-alkyl or a phenyl or heterocyclic radical, and wherein the phenyl and heterocyclic radicals may additionally carry substituents which do not confer solubility in water, anthrapyrimidinecarboxylic acid amides, violanthrone, isoviolanthrone, dioxazine pigments, copper phthalocyanine which may contain up to 2 chlorine atoms per molecule, polychloro-copper phthalocyanine or polybromochloro-copper phthalocyanine containing up to 14 bromine atoms per molecule and mixtures thereof. In another aspect, suitable pigments include pigments selected from the group consisting of Ultramarine Blue (C.I. Pigment Blue 29), Ultramarine Violet (C.I. Pigment Violet 15), Monastral Blue and mixtures thereof.

The aforementioned fabric hueing agents can be used in combination (any mixture of fabric hueing agents can be used).

Suitable electrolytes for use in the present invention include alkali metal and alkaline earth metal salts such as those derived from potassium, sodium, calcium, magnesium.

Silicones—Suitable silicones comprise Si—O moieties and may be selected from (a) non-functionalized siloxane polymers, (b) functionalized siloxane polymers, and combinations thereof. The molecular weight of the organosilicone is usually indicated by the reference to the viscosity of the material. In one aspect, the organosilicones may comprise a viscosity of from about 10 to about 2,000,000 centistokes at 25° C. In another aspect, suitable organosilicones may have a viscosity of from about 10 to about 800,000 centistokes at 25° C.

Suitable organosilicones may be linear, branched or cross-linked. In one aspect, the organosilicones may comprise of silicone resins. Silicone resins are highly cross-linked polymeric siloxane systems. The cross-linking is introduced through the incorporation of trifunctional and tetrafunctional silanes with monofunctional or difunctional, or both, silanes during manufacture of the silicone resin.

Silicone materials and silicone resins in particular, can conveniently be identified according to a shorthand nomenclature system known to those of ordinary skill in the art as “MDTQ” nomenclature. Under this system, the silicone is described according to presence of various siloxane monomer units which make up the silicone. Briefly, the symbol M denotes the monofunctional unit (CH₃)₃SiO_{0.5}; D denotes the difunctional unit (CH₃)₂SiO; T denotes the trifunctional unit (CH₃)SiO_{1.5}; and Q denotes the quadra- or tetra-functional unit SiO₂. Primes of the unit symbols (e.g. M′, D′, T′, and Q′) denote substituents other than methyl, and must be specifically defined for each occurrence.

In one aspect, silicone resins for use in the compositions of the present invention include, but are not limited to MQ, MT, MTQ, MDT and MDTQ resins. In one aspect, Methyl is a highly suitable silicone substituent. In another aspect, silicone resins are typically MQ resins, wherein the M:Q ratio is typically from about 0.5:1.0 to about 1.5:1.0 and the average molecular weight of the silicone resin is typically from about 1000 to about 10,000.

Other modified silicones or silicone copolymers are also useful herein. Examples of these include silicone-based quaternary ammonium compounds (Kennan quats) disclosed in U.S. Pat. Nos. 6,607,717 and 6,482,969; end-terminal quaternary siloxanes; silicone aminopolyalkyleneoxide block copolymers disclosed in U.S. Pat. Nos. 5,807,956 and 5,981,681; hydrophilic silicone emulsions disclosed in U.S. Pat. No. 6,207,782; and polymers made up of one or more crosslinked rake or comb silicone copolymer segments disclosed in U.S. Pat. No. 7,465,439. Additional modified silicones or silicone copolymers useful herein are described in US Patent Application Nos. 2007/0286837A1 and 2005/0048549A1.

In alternative embodiments of the present invention, the above-noted silicone-based quaternary ammonium compounds may be combined with the silicone polymers described in U.S. Pat. Nos. 7,041,767 and 7,217,777 and US Application number 2007/0041929A1.

In one aspect, the organosilicone may comprise a non-functionalized siloxane polymer that may have Formula (XXIV) below, and may comprise polyalkyl and/or phenyl silicone fluids, resins and/or gums.

[R₁R₂R₃SiO_{1/2}]ₙ[R₄R₄SiO_{2/2}]ₘ[R₄SiO_{3/2}]ⱼ Formula (XXIV)

wherein:
i) each R₁, R₂, R₃ and R₄ may be independently selected from the group consisting of H, —OH, C₁-C₂₀ alkyl, C₁-C₂₀ substituted alkyl, C₆-C₂₀ aryl, C₆-C₂₀ substituted aryl, alkylaryl, and/or C₁-C₂₀ alkoxy, moieties;
ii) n may be an integer from about 2 to about 10, or from about 2 to about 6; or 2; such that n=j+2;
iii) m may be an integer from about 5 to about 8,000, from about 7 to about 8,000 or from about 15 to about 4,000;
iv) j=0;

In one aspect, R₂, R₃ and R₄ may comprise methyl, ethyl, propyl, C₄-C₂₀ alkyl, and/or C₆-C₂₀ aryl moieties. In one aspect, each of R₂, R₃ and R₄ may be methyl. Each R₁ moiety blocking the ends of the silicone chain may comprise a moiety selected from the group consisting of hydrogen, methyl, methoxy, ethoxy, hydroxy, propoxy, and/or aryloxy.

As used herein, the nomenclature SiO“n”/2 represents the ratio of oxygen and silicon atoms. For example, SiO_{1/2} means that one oxygen is shared between two Si atoms. Likewise SiO_{2/2} means that two oxygen atoms are shared between two Si atoms and SiO_{3/2} means that three oxygen atoms are shared are shared between two Si atoms.

In one aspect, the organosilicone may be polydimethylsiloxane, dimethicone, dimethiconol, dimethicone crosspolymer, phenyl trimethicone, alkyl dimethicone, lauryl dimethicone, stearyl dimethicone and phenyl dimethicone. Examples include those available under the names DC 200 Fluid, DC 1664, DC 349, DC 346G available from Dow Corning® Corporation, Midland, Mich., and those available under the trade names SF1202, SF1204, SF96, and Viscasil® available from Momentive Silicones, Waterford, N.Y.

In one aspect, the organo silicone may comprise a cyclic silicone. The cyclic silicone may comprise a cyclomethicone of the formula [(CH₃)₂SiO]ₙ where n is an integer that may range from about 3 to about 7, or from about 5 to about 6.

In one aspect, the organosilicone may comprise a functionalized siloxane polymer. Functionalized siloxane polymers may comprise one or more functional moieties selected from the group consisting of amino, amido, alkoxy, hydroxy, polyether, carboxy, hydride, mercapto, sulfate phosphate, and/or quaternary ammonium moieties. These moieties may be attached directly to the siloxane backbone through a bivalent alkylene radical, (i.e., “pendant”) or may be part of the backbone. Suitable functionalized siloxane polymers include materials selected from the group consisting of aminosilicones, amidosilicones, silicone polyethers, silicone-urethane polymers, quaternary ABn silicones, amino ABn silicones, and combinations thereof.

In one aspect, the functionalized siloxane polymer may comprise a silicone polyether, also referred to as “dimethicone copolyol.” In general, silicone polyethers comprise a polydimethylsiloxane backbone with one or more polyoxyalkylene chains. The polyoxyalkylene moieties may be incorporated in the polymer as pendent chains or as terminal blocks. Such silicones are described in USPA 2005/0098759, and U.S. Pat. Nos. 4,818,421 and 3,299,112. Exemplary commercially available silicone polyethers include DC 190, DC 193, FF400, all available from Dow Corning® Corporation, and various Silwet® surfactants available from Momentive Silicones.

In another aspect, the functionalized siloxane polymer may comprise an aminosilicone. Suitable aminosilicones are described in U.S. Pat. Nos. 7,335,630 B2, 4,911,852, and USPA 2005/0170994A1. In one aspect the aminosilicone may be that described in USPA 61/221,632. In another aspect, the aminosilicone may comprise the structure of Formula (XXV):

[R₁R₂R₃SiO_{1/2}]ₙ[(R₄Si(X-Z)O_{2/2}]ₖ[R₄R₄SiO_{2/2}]ₘ[R₄SiO_{3/2}]ⱼ Formula (XXV)

wherein
i. R₁, R₂, R₃ and R₄ may each be independently selected from H, OH, C₁-C₂₀ alkyl, C₁-C₂₀ substituted alkyl, C₆-C₂₀ aryl, C₆-C₂₀ substituted aryl, alkylaryl, and/or C₁-C₂₀ alkoxy;
ii. Each X may be independently selected from a divalent alkylene radical comprising 2-12 carbon atoms, —(CH₂)ₛ— wherein s may be an integer from about 2 to about 10;

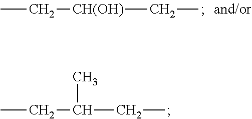

iii. Each Z may be independently selected from —N(R₅)₂;

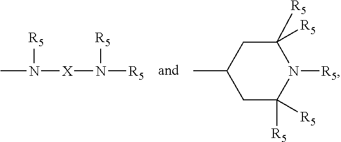

wherein each R₅ may be selected independently selected from H, C₁-C₂₀ alkyl; and A⁻ may be a compatible anion. In one aspect, A⁻ may be a halide;
iv. k may be an integer from about 3 to about 20, from about 5 to about 18 more or even from about 5 to about 10;
v. m may be an integer from about 100 to about 2,000, or from about 150 to about 1,000;
vi. n may be an integer from about 2 to about 10, or about 2 to about 6, or 2, such that n=j+2; and
vii. j may be an integer from 0 to about 10, or from 0 to about 4, or 0;

In one aspect, R₁ may comprise —OH. In this aspect, the organosilicone is amidomethicone.

Exemplary commercially available aminosilicones include DC 8822, 2-8177, and DC-949, available from Dow Corning® Corporation, and KF-873, available from Shin-Etsu Silicones, Akron, Ohio.
In one aspect, the organosilicone may comprise amine ABn silicones and quat ABn silicones. Such organosilicones are generally produced by reacting a diamine with an epoxide. These are described, for example, in U.S. Pat. Nos. 6,903,061 B2, 5,981,681, 5,807,956, 6,903,061 and 7,273,837. These are commercially available under the trade names Magnasoft® Prime, Magnasoft® JSS, Silsoft® A-858 (all from Momentive Silicones).

In another aspect, the functionalized siloxane polymer may comprise silicone-urethanes, such as those described in USPA 61/170,150. These are commercially available from Wacker Silicones under the trade name SLM-21200®.

When a sample of organosilicone is analyzed, it is recognized by the skilled artisan that such sample may have, on average, the non-integer indices for Formula (XXIV) and (XXV) above, but that such average indices values will be within the ranges of the indices for Formula (XXIV) and (XXV) above.

In one aspect of the compositions disclosed herein comprise a perfume and or perfume delivery system. As used herein the term “perfume” is used to indicate any odoriferous material that is subsequently released into the aqueous bath and/or onto fabrics contacted therewith. Suitable perfume delivery systems, methods of making perfume delivery systems and the uses of perfume delivery systems are disclosed in USPA 2007/0275866 A1. Such perfume delivery systems include:

I. Polymer Assisted Delivery (PAD):

This perfume delivery technology uses polymeric materials to deliver benefit agents (e.g., perfumes). Examples of PAD include employment of classical coacervation, water soluble or partly soluble to insoluble charged or neutral polymers, liquid crystals, hot melts, hydrogels, perfumed plastics, microcapsules, nano- and micro-latexes, polymeric film formers, and polymeric absorbents, polymeric adsorbents, etc. Further, PAD includes but is not limited to:

a.) Matrix Systems: The benefit agent is dissolved or dispersed in a polymer matrix or particle. Perfumes, for example, may be 1) dispersed into the polymer prior to formulating into the product or 2) added separately from the polymer during or after formulation of the product. Examples include those with amine functionality, which may be used to provide benefits associated with amine-assisted delivery (AAD) and/or polymer-assisted delivery (PAD) and/or amine-reaction products (ARP).

b.) Reservoir Systems: Reservoir systems are also known as a core-shell system (e.g., perfume microcapsules). In such a system, the benefit agent is surrounded by a benefit agent release controlling membrane, which may serve as a protective shell. Suitable shell materials include reaction products of one or more amines with one or more aldehydes, such as urea cross-linked with formaldehyde or gluteraldehyde, melamine cross-linked with formaldehyde; gelatin-polyphosphate coacervates optionally cross-linked with gluteraldehyde; gelatin-gum Arabic coacervates; cross-linked silicone fluids; polyamine reacted with polyisocyanates, polyamines reacted with epoxides, polyvinyl alcohol cross linked with gluteraldehyde, polydivinyl chloride, polyacrylate, in one aspect said polyacrylate based materials may comprise polyacrylate formed from methylmethacrylate/dimethylaminomethyl methacrylate, polyacrylate formed from amine acrylate and/or methacrylate and strong acid, polyacrylate formed from carboxylic acid acrylate and/or methacrylate monomer and strong base, polyacrylate formed from an amine acrylate and/or methacrylate monomer and a carboxylic acid acrylate and/or carboxylic acid methacrylate monomer, and mixtures thereof.

Suitable core materials include perfume compositions, and/or perfume raw materials, Suitable perfume compositions may comprise enduring perfumes, such as perfume raw materials that have a cLogP greater than about 2.5 and a boiling point greater than about 250° C. Further, suitable perfume compositions may comprise blooming perfumes that comprise perfume raw materials that have a cLogP of greater than about 3 and a boiling point of less than about 260° C.

Suitable core materials being stabilized, emulsified, in the solvent systems with organic or inorganic materials, organic materials can be polymers of anionic, non-ionic nature or cationic nature, like polyacrylates, polyvinyl alcohol. Suitable processes to make core shell systems include coating, extrusion, spray drying, interfacial polymerization, polycondensation, simple coacervation, complex coacervation, free radical polymerization, in situ emulsion polymerization, matrix polymerization and combinations thereof.

Suitable characteristics for core shell systems include:
a) a shell thickness of from about 20 nm to about 500 nm, from about 40 nm to about 250 nm, or from about 60 nm to about 150 nm;
b) a shell core ratio of from about 5:95 to about 50:50, from about 10:90 to about 30:70, or from about 10:90 to about 15:85;
c) a fracture strength of from about 0.1 MPa to about 16 MPa, from about 0.5 MPa to about 8 MPa, or even from about 1 MPa to about 3 MPa; and
d) an average particle size of from about 1 micron to about 100 microns, from about 5 microns to about 80 microns, or even from about 15 microns to about 50 microns.

Suitable deposition and/or retention enhancing coatings that may be applied to the core shell systems include cationic polymers such as polysaccharides including, but not limited to, cationically modified starch, cationically modified guar, polysiloxanes, poly diallyl dimethyl ammonium halides, copolymers of poly diallyl dimethyl ammonium chloride and vinyl pyrrolidone, acrylamides, imidazoles, imidazolinium halides, imidazolium halides, poly vinyl amine, copolymers of poly vinyl amine and N-vinyl formamide and mixtures thereof. In another aspect, suitable coatings may be selected from the group consisting of polyvinylformaldehyde,

partially hydroxylated polyvinylformaldehyde, polyvinylamine, polyethyleneimine, ethoxylated

polyethyleneimine, polyvinylalcohol, polyacrylates, and combinations thereof.

Suitable methods of physically reducing any residual type materials may be employed, such as centrifugation, to remove undesirable materials. Suitable methods of chemically reducing any residual type materials may also be employed, such as the employment of scavengers, for example formaldehyde scavengers including sodium bisulfite, urea, ethylene urea, cysteine, cysteamine, lysine, glycine, serine, carnosine, histidine, glutathione, 3,4-diaminobenzoic acid, allantoin, glycouril, anthranilic acid, methyl anthranilate, methyl 4-aminobenzoate, ethyl acetoacetate, acetoacetamide, malonamide, ascorbic acid, 1,3-dihydroxyacetone dimer, biuret, oxamide, benzoguanamine, pyroglutamic acid, pyrogallol, methyl gallate, ethyl gallate, propyl gallate, triethanol amine, succinamide, thiabendazole, benzotriazol, triazole, indoline, sulfanilic acid, oxamide, sorbitol, glucose, cellulose, poly(vinyl alcohol), partially hydrolyzed poly(vinylformamide), poly(vinyl amine), poly(ethylene imine), poly(oxyalkyleneamine), poly(vinyl alcohol)-co-poly(vinyl amine), poly(4-aminostyrene), poly(1-lysine), chitosan, hexane diol, ethylenediamine-N,N′-bisacetoacetamide, N-(2-ethylhexyl)acetoacetamide, 2-benzoylacetoacetamide, N-(3-phenylpropyl)acetoacetamide, lilial, helional, melonal, triplal, 5,5-dimethyl-1,3-cyclohexanedione, 2,4-dimethyl-3-cyclohexenecarboxaldehyde, 2,2-dimethyl-1,3-dioxan-4,6-dione, 2-pentanone, dibutyl amine, triethylenetetramine, ammonium hydroxide, benzylamine, hydroxycitronellol, cyclohexanone, 2-butanone, pentane dione, dehydroacetic acid, or a mixture thereof.

III. Amine Assisted Delivery (AAD):

The amine-assisted delivery technology approach utilizes materials that contain an amine group to increase perfume deposition or modify perfume release during product use. There is no requirement in this approach to pre-complex or pre-react the perfume raw material(s) and the amine prior to addition to the product. In one aspect, amine-containing AAD materials suitable for use herein may be non-aromatic; for example, polyalkylimine, such as polyethyleneimine (PEI), or polyvinylamine (PVAm), or aromatic, for example, anthranilates. Such materials may also be polymeric or non-polymeric. In one aspect, such materials contain at least one primary amine. In another aspect, a material that contains a heteroatom other than nitrogen, for example sulfur, phosphorus or selenium, may be used as an alternative to amine compounds. In yet another aspect, the aforementioned alternative compounds can be used in combination with amine compounds. In yet another aspect, a single molecule may comprise an amine moiety and one or more of the alternative heteroatom moieties, for example, thiols, phosphines and selenols.

IV. Pro-Perfume (PP):

This technology refers to perfume technologies that result from the reaction of perfume materials with other substrates or chemicals to form materials that have a covalent bond between one or more PRMs and one or more carriers. The PRM is converted into a new material called a pro-PRM (i.e., pro-perfume), which then may release the original PRM upon exposure to a trigger such as water or light. Nonlimiting examples of pro-perfumes include Michael adducts (e.g., beta-amino ketones), aromatic or non-aromatic imines (Schiffs Bases), oxazolidines, beta-keto esters, and orthoesters. Another aspect includes compounds comprising one or more beta-oxy or beta-thio carbonyl moieties capable of releasing a PRM, for example, an alpha, beta-unsaturated ketone, aldehyde or carboxylic ester.

a.) Amine Reaction Product (ARP): For purposes of the present application, ARP is a subclass or species of PP. One may also use “reactive” polymeric amines in which the amine functionality is pre-reacted with one or more PRMs, typically PRMs that contain a ketone moiety and/or an aldehyde moiety, to form an amine reaction product (ARP). Typically, the reactive amines are primary and/or secondary amines, and may be part of a polymer or a monomer (non-polymer). Such ARPs may also be mixed with additional PRMs to provide benefits of polymer-assisted delivery and/or amine-assisted delivery. Nonlimiting examples of polymeric amines include polymers based on polyalkylimines, such as polyethyleneimine (PEI), or polyvinylamine (PVAm). Nonlimiting examples of monomeric (non-polymeric) amines include hydroxyl amines, such as 2-aminoethanol and its alkyl substituted derivatives, and aromatic amines such as anthranilates. The ARPs may be premixed with perfume or added separately in leave-on or rinse-off applications. In another aspect, a material that contains a heteroatom other than nitrogen, for example oxygen, sulfur, phosphorus or selenium, may be used as an alternative to amine compounds. In yet another aspect, the aforementioned alternative compounds can be used in combination with amine compounds. In yet another aspect, a single molecule may comprise an amine moiety and one or more of the alternative heteroatom moieties, for example, thiols, phosphines and selenols.

Suitable perfume delivery systems, methods of making certain perfume delivery systems and the uses of such perfume delivery systems are disclosed in USPA 2007/0275866 A1. In one aspect, the fabric care composition comprises from about 0.01% to about 5%, alternatively from about 0.5% to about 3%, or from about 0.5% to about 2%, or from about 1% to about 2% neat perfume by weight of the fabric care composition.

In one aspect, the compositions of the present invention comprises perfume oil encapsulated in a perfume microcapsule (PMC), preferable a friable PMC. In another aspect, the perfume microcapsule comprises a friable microcapsule. In another aspect, the PMC shell may comprise an aminoplast copolymer, esp. melamine-formaldehyde or urea-formaldehyde or cross-linked melamine formaldehyde or the like. In another aspect, the PMC shell may be a shell that comprises an acrylic material. Capsules may be obtained from Appleton Papers Inc., of Appleton, Wis. USA. Formaldehyde scavengers may also be used.

In one aspect, the compositions of the present invention are free or substantially free of detersive surfactants. In one aspect, the composition comprises less than about 5% of a detersive surfactant, alternatively less than about 2%, alternatively less than about 1%, alternatively less than 0.5%, by weight of the composition.

In another aspect, the fabric enhancers of the present invention are free or substantially free of biological active (cosmetic or pharmaceutical) agents which are suited towards treating the symptoms and/or disorders of living organisms, notably of the skin and hair. Further, in one aspect, the composition is free of materials which are oxygen sensitive (e.g. agents such as retinol).

### Processes Of Making

The compositions disclosed herein may be made by combining the ingredients. Such combining can be achieved in a variety of ways including simple mixing.

Method of Use

The compositions of the present invention may be used to treat fabric by administering a dose to a laundry washing machine or directly to fabric (e.g., spray). Such method comprises contacting the fabric with a composition described in the present specification. The compositions may be administered to a laundry washing machine during the rinse cycle or at the beginning of the wash cycle, typically during the rinse cycle. The fabric care compositions of the present invention may be used for handwashing as well as for soaking and/or pretreating fabrics. The composition may be in the form of a powder/granule, a bar, a pastille, foam, flakes, a liquid, a dispersible substrate, or as a coating on a dryer added fabric softener sheet. The composition may be administered to the washing machine as a unit dose or dispensed from a container (e.g., dispensing cap) containing multiple doses. An example of a unit dose is a composition encased in a water soluble polyvinylalcohol film.

In one aspect, a method of treating and/or cleaning a situs, said method comprising
a) optionally washing and/or rinsing said situs;
b) contacting said situs with a liquid fabric enhancer composition disclosed herein; and
c) optionally washing and/or rinsing said situs.
d) optionally drying said situs via and automatic dryer and/or line drying is disclosed.

### Synthetic Methods and Examples

### Synthesis Examples of DADMAC Based Polymers

### Example P1

In a 4 L stirred vessel, water (1148.8 g), diethylentriaminepentaacetic acid, pentasodium (0.99 g), glycidylmethacrylate (5.19 g), vinylpyrrolidone (5.63 g), acrylamide in water (50%, 50.28 g), and diallyldimethylammonium chloride in water (65%, 96.86 g) were charged and heated to 80° C. under a flow of nitrogen. A solution of sodium persulfate (2.47 g) in water (98.9 g) is added over 4 h. Once the persulfate solution has been fed for 15 min, a solution of glycidylmethacrylate (34.78 g), vinylpyrrolidone (22.52 g), acrylamide in water (50%, 201.14 g), diallyldimethylammonium chloride in water (65%, 387.42 g) and water (357.37 g) are added together in one feed over 2 h and 45 min. The polymerization mixture is kept at this temperature for an additional 1 h after both streams have finished. Subsequently a solution of sodium persulfate (2.47 g) in water (98.83 g) is added over 1 h, the reaction kept at this temperature for 2 h and then left to cool down to room temperature. To the tetrapolymer solution the silicon polymer amino silicone 3S (24.96 g) is added, stirred vigorously while heating to 80° C. and kept at this temperature for 1 h. The mixture is then cooled down to room temperature and filtered over a ED-Schnellsieb 400μ to yield the silicon functionalized product.

### Example P2

In a 4 L stirred vessel, water (1128.92 g), diethylentriaminepentaacetic acid, pentasodium (0.99 g), glycidylmethacrylate (7.97 g), acrylamide in water (50%, 127.45 g), and diallyldimethylammonium chloride in water (65%, 41.81 g) were charged and heated to 80° C. under a flow of nitrogen. A solution of sodium persulfate (2.47 g) in water (98.8 g) is added over 4 h. Once the persulfate solution has been fed for 15 min, a solution of glycidylmethacrylate (31.86 g), acrylamide in water (50%, 509.82 g), diallyldimethylammonium chloride in water (65%, 167.25 g) and water (279.78 g) are added together in one feed over 2 h and 45 min. The polymerization mixture is kept at this temperature for an additional 1 h after both streams have finished. Subsequently a solution of sodium persulfate (2.47 g) in water (98.83 g) is added over 1 h, the reaction kept at this temperature for 2 h and then left to cool down to room temperature. To the terpolymer solution the silicon polymer amino silicone 3S (24.96 g) is added, stirred vigorously while heating to 80° C. and kept at this temperature for 1 h. The mixture is then cooled down to room temperature and filtered over a ED-Schnellsieb 400μ to yield the silicon functionalized product.

### Example P3

In a 4 L stirred vessel, water (1152.77 g), diethylentriaminepentaacetic acid, pentasodium (0.99 g), glycidylmethacrylate (4.12 g), acrylamide in water (50%, 15.05 g), and diallyldimethylammonium chloride in water (65%, 134.19 g) were charged and heated to 80° C. under a flow of nitrogen. A solution of sodium persulfate (2.47 g) in water (98.8 g) is added over 4 h. Once the persulfate solution has been fed for 15 min, a solution of glycidylmethacrylate (16.49 g), acrylamide in water (50%, 60.21 g), diallyldimethylammonium chloride in water (65%, 536.75 g) and water (375.28 g) are added together in one feed over 2 h and 45 min. The polymerization mixture is kept at this temperature for an additional 1 h after both streams have finished. Subsequently a solution of sodium persulfate (2.47 g) in water (98.83 g) is added over 1 h, the reaction kept at this temperature for 2 h and then left to cool down to room temperature. To the terpolymer solution the silicon polymer amino silicone 3S (24.96 g) is added, stirred vigorously while heating to 80° C. and kept at this temperature for 1 h. The mixture is then cooled down to room temperature and filtered over a ED-Schnellsieb 400μ to yield the silicon functionalized product.

### Example P4

In a 2 L stirred vessel, water (557.7 g), diethylentriaminepentaacetic acid, pentasodium (0.48 g), glycidylmethacrylate (5.74 g), acrylamide in water (50%, 25.81 g), and diallyldimethylammonium chloride in water (65%, 45.16 g) were charged and heated to 80° C. under a flow of nitrogen. A solution of sodium persulfate (1.20 g) in water (48.0 g) is added over 4 h. Once the persulfate solution has been fed for 15 min, a solution of glycidylmethacrylate (22.94 g), acrylamide in water (50%, 103.26 g), diallyldimethylammonium chloride in water (65%, 180.66 g) and water (172.8 g) are added together in one feed over 2 h and 45 min. The polymerization mixture is kept at this temperature for an additional 1 h after both streams have finished. Subsequently a solution of sodium persulfate (1.20 g) in water (48.00 g) is added at once, the reaction kept at this temperature for 2 h and then left to cool down to room temperature. To the terpolymer solution the silicon polymer amino silicone 3S (24.96 g, in this case the polymer was split in three and only 7.8 g silicon added) is added, stirred vigorously while heating to 80° C. and kept at this temperature for 1 h. The mixture is then cooled down to room temperature and filtered over a ED-Schnellsieb 400μ to yield the silicon functionalized product.

### Example P5

In a 2 L stirred vessel, water (998.02 g), diethylentriaminepentaacetic acid, pentasodium (0.64 g) and glycidylmethacrylate (1.78 g), were charged and heated to 80° C. under a flow of nitrogen. A solution of sodium persulfate (1.58 g) in water (63.17 g) is added over 6 h. Once the persulfate solution has been fed for 15 min, glycidylmethacrylate (7.12 g), and diallyldimethylammonium chloride in water (65%, 443.71 g) are added in two independent feeds over 2 h and 45 min. The polymerization mixture is kept at this temperature for an additional 1 h after both streams have finished. Subsequently a solution of sodium persulfate (1.58 g) in water (63.17 g) is added at once, the reaction kept at this temperature for 2 h and then left to cool down to room temperature. To the copolymer solution the silicon polymer amino silicone 3S (24.96 g) is added, stirred vigorously while heating to 80° C. and kept at this temperature for 1 h. The mixture is then cooled down to room temperature and filtered over a ED-Schnellsieb 400μ to yield the silicon functionalized product.

### Example P6

14.02 grams of 5000 molecular weight mono methacrylate terminated polydimethylsiloxane (available from Gelest Inc., Morrisville, Pa.), 6.13 grams of dimethylaminoethylmethacrylate (available from Sigma-Aldrich, Milwaukee Wis.), 20 milliliters of benzene (available from Sigma-Aldrich, Milwaukee Wis.) and 0.0551 grams of 2,2-azobis(2,4-dimethyl-4-methoxyvaleronitrile) (available as V-70 from Wako Chemicals, Richmond, Va.) are added to a reactor. The reactor is then sealed with a septa and the contents are then sparged with nitrogen via a gas bubbler for 15 minutes. After 15 minutes the reactor is warmed to 65 C and held at 65 C for 24 hours.

### Example P7

14.05 grams of 5000 molecular weight mono methacrylate terminated polydimethylsiloxane (available from Gelest Inc., Morrisville, Pa.), 3.04 grams of 2-ethylhexyl methacrylate (available from Sigma-Aldrich, Milwaukee Wis.), 3.09 grams of dimethylaminoethylmethacrylate (available from Sigma-Aldrich, Milwaukee Wis.), 20 milliliters of benzene (available from Sigma-Aldrich, Milwaukee Wis.) and 0.0577 grams of 2,2-azobis(2,4-dimethyl-4-methoxyvaleronitrile) (available as V-70 from Wako Chemicals, Richmond, Va.) are added to a reactor. The reactor is then sealed with a septa and the contents are then sparged with nitrogen via a gas bubbler for 15 minutes. After 15 minutes the reactor is warmed to 65 C and held at 65 C for 24 hours.

### Example P8

14.02 grams of 5000 molecular weight mono methacrylate terminated polydimethylsiloxane (available from Gelest Inc., Morrisville, Pa.), 6.00 grams of dimethylaminoethylmethacrylate (available from Sigma-Aldrich, Milwaukee Wis.), 20 milliliters of toluene (available from Sigma-Aldrich, Milwaukee Wis.) and 0.05 grams of Dimethyl 2,2′-azobis(2-methylpropionate) (available as V-601 from Wako Chemicals, Richmond, Va.) are added to a reactor. The reactor is then sealed with a septa and the contents are then sparged with nitrogen via a gas bubbler for 15 minutes. After 15 minutes the reactor is warmed to 65 C and held at 65 C for 24 hours. After 24 hours the reaction is precipitated by pouring the reaction solution into 200 milliliters of acetonitrile ((available from Sigma-Aldrich, Milwaukee Wis.). The fluid layer is filtered away from the polymer and the polymer is rinsed with 200 milliliters of additional acetonitrile. The polymer is then dissolved by adding 100 milliliter of isopropanol (available from Sigma-Aldrich, Milwaukee Wis.) and stirring for 2 hours. 83.15 grams of bromobutane (available from Sigma-Aldrich, Milwaukee Wis.) is added to the polymer solution. The reactor is sealed with a septa and the polymer solution is heated to 4° C. in a water bath for 16 hours. After 24 hours the reaction is vacuum stripped.
7.01 grams of approximately 1900 molecular weight Methoxypoly(ethyleneoxy)ethyl acrylate (available from Monomer-Polymer & Dajac Labs, Trevose, Pa.), 6.06 grams of 5000 molecular weight mono methacrylate terminated polydimethylsiloxane (available from Gelest Inc., Morrisville, Pa.), 7.01 grams of dimethylaminoethylmethacrylate (available from Monomer-Polymer—Dajac,), 35 milliliters of toluene (available from Sigma-Aldrich, Milwaukee Wis.), 35 milliliters of ethyl acetate (available from Sigma-Aldrich, Milwaukee Wis.) and 0.15 grams of Dimethyl 2,2′-azobis(2-methylpropionate) (available as V-601 from Wako Chemicals, Richmond, Va.) are added to a reactor. The reactor is then sealed with a septa and the contents are then sparged with nitrogen via a gas bubbler for 15 minutes. After 15 minutes the reactor is warmed to 65 C and held at 65 C for 24 hours. After 24 hours the reaction is precipitated by pouring the reaction solution into 200 milliliters of acetonitrile ((available from Sigma-Aldrich, Milwaukee Wis.). The fluid layer is filtered away from the polymer and the polymer is rinsed with 200 milliliters of additional acetonitrile. The polymer is then dissolved by adding 100 milliliter of isopropanol (available from Sigma-Aldrich, Milwaukee Wis.) and stirring for 2 hours. 83.15 grams of bromobutane (available from Sigma-Aldrich, Milwaukee Wis.) is added to the polymer solution. The reactor is sealed with a septa and the polymer solution is heated to 4° C. in a water bath for 16 hours. After 24 hours the reaction is vacuum stripped.

TABLE 1
Particle Compositions

| | Components | | | | | GPC | |
|---|---|---|---|---|---|---|---|
| | wt % in Functionalized polymer | | | | | Mn | Mw |
| | AA | VP | DADMAC | GMA | Silicone | (g/mol) | (g/mol) |
| P1 | 24.1 | 5.4 | 60.5 | 5.0 | 5.0 | 43600.0 | 194000.0 |
| P2-a | 59.7 | 0.0 | 25.5 | 7.4 | 7.4 | 80800.0 | 496000.0 |
| P2-b | 59.7 | 0.0 | 25.5 | 7.4 | 7.4 | 76100.0 | 424000.0 |
| P2-c | 59.7 | 0.0 | 25.5 | 7.4 | 7.4 | 75700.0 | 418000.0 |
| P3 | 7.3 | 0.0 | 84.7 | 4.0 | 4.0 | 33300.0 | 95300.0 |
| P4 | 24.0 | 0.0 | 54.6 | 10.7 | 10.7 | 41300.0 | 246000.0 |
| P5 | 0.0 | 0.0 | 81.8 | 9.1 | 9.1 | 26400.0 | 132000.0 |
| P6 | 63.4 | 18.1 | 9.1 | 4.7 | 4.7 | | |
| P7 | 62.3 | 6.7 | 18.6 | 6.2 | 6.2 | 73100.0 | 452000.0 |
| P8 | 30.9 | 7.8 | 51.6 | 4.9 | 4.9 | 50600.0 | 245000.0 |
| P9 | 35.0 | 0.0 | 55.5 | 4.8 | 4.8 | 41200.0 | 205000.0 |
| P10 | 6.5 | 0.0 | 75.8 | 8.9 | 8.9 | 28200.0 | 143000.0 |
| P11-a | 6.5 | 0.0 | 75.8 | 8.9 | 8.9 | 28500.0 | 142000.0 |
| P11-b | 6.5 | 0.0 | 75.8 | 8.9 | 8.9 | 28500.0 | 142000.0 |
| P11-c | 51.2 | 0.0 | 21.8 | 13.5 | 13.5 | | |

### Formulation Examples

### Example 1

### Particle Made in the Presence of Non-Ionic Emulsifiers (2 Different HLB's)

Preparation of a H₂O/Si emulsion, using low HLB surfactant/emulsifier then invert during dilution to form Si/H2O emulsion.

| RM | Examples | Level (wt. %) |
|---|---|---|
| Silicone fluid | Amino Silicone or PDMS | 40% |
| Emulsifier #1 | Tergitol 15-s-5 | 1.25 |
| Polymer | Polymer P3 from Table 1 | 1.8% |
| Emulsifier #2 | Tergitol 15-s-12 | 1.93 |
| Water | Distilled | To 100% |
| Acetic Acid | Glacial | to pH 5 |

Using IKA T25 Ultra-Turrax disperser (300 W Output) and IKA Dispersing element (S25N-25G), in a non-plastic container, add silicone fluid and polymer. Mix for 5 minutes at 500 RPM. Add Emulsifier #1, mix for 5 min at 500 RP. In a separate container, blend Emulsifier #2 and water, mix until completely dispersed. Add water+emulsifier #2 composition to Silicone/polymer/emulsifier #1 composition, in 3 equal aliquots. After addition of each aliquot, mix at 3,000 RPM until homogeneous and uniform consistency. After all of the water+emulsifier #2 is combined, add glacial acetic acid to adjust pH, mix for 20 minutes at 3,000 RPM.

### Example 2

### Non-Ionic Emulsifier (1 Non-Ionic Surfactant/Emulsifier)

### Preparation Via Single Emulsifier Preparation Method

| RM | Examples | Level (wt. %) |
|---|---|---|
| Water | Distilled | To 100% |
| Emulsifier #1 | Lutensol XP70 (BASF) | 5% |
| Silicone fluid | Amino Silicone or PDMS | 40% |
| Polymer | Polymer P3 from Table 1 | 4% |
| Acetic Acid | Glacial | to pH 5 |

Using IKA T25 Ultra-Turrax disperser (300 W Output) and IKA Dispersing element (S25N-25G), in a non-plastic container, blend Emulsifier #1 and water, mix until completely dispersed. In a separate non-plastic container, fluid and polymer. Mix for 5 minutes at 500 RPM. Add Silicone polymer composition to the water/emulsifier #1 composition at approximately 10 gram/min, with constant mixing at 3,000 RPM. Mix entire composition for 20 minutes at 3,000 RPM. Add glacial acetic acid to adjust pH, mix for 3 minutes at 3,000 RPM.

### Example 3

### Polymer Emulsifier (No Added Surfactant/Emulsifier)

### Preparation Via Single Emulsifier Using Polymer Emulsifier Preparation Method

| RM | Examples | Level (wt. %) |
|---|---|---|
| Polymer | Polymer P3 from Table 1 | 2.25% |
| Water | Distilled | To 100% |
| Silicone fluid | Amino Silicone or PDMS | 40% |
| Acetic Acid | Glacial | to pH 5 |

Follow preparation method in Example #2 except add polymer to water and no addition to silicone fluid.

### Example 4

### Polymer Emulsifier (No Added Surfactant/Emulsifier)

Preparation via single emulsifier using polymer emulsifier preparation method. The materials and level are the same as in Example 2 except polymer is added to the silicone and 5% of the total water is added to the silicone+polymer composition.

| RM | Examples | Level (wt. %) |
|---|---|---|
| Silicone fluid | Amino Silicone or PDMS | 40% |
| Polymer | Polymer P3 from Table 1 | 2.25% |
| Water | Distilled | 5% of total emulsion |
| | | volume |
| Water | Distilled | To 100% |
| Acetic Acid | Glacial | to pH 5 |

### Example 5

### In-Situ: In Product Particle Formation (No Added Surfactant/Emulsifier)

### Preparation Via Single Emulsifier Preparation Method

| RM | Examples | Level (wt. %) |
|---|---|---|
| Silicone fluid | Amino Silicone or PDMS | 99% |
| Polymer | Polymer P3 from Table 1 | 1% |

Using a IKA-RW20 overhead mixer with a 90 degree flat blade impeller, in a non-plastic container, blend polymer and silicone for 20 minutes @ 500 RPM until uniformly dispersed.

### Example 6

### Heavy Duty Liquid Detergents Formulation Examples

The following heaving duty liquid detergents are made by mixing the ingredients listed below via conventional processes. Such heavy duty liquid detergents are used to launder fabrics that are then dried by line drying and/or machine drying. Such fabrics may be treated with a fabric enhancer prior to and/or during drying. Such fabrics exhibit a clean appearance and have a soft feel.

TABLE I
Heavy Duty Liquid Detergent Formulation Examples

| Ingredient (wt. %) | 1 | 2 | 3 | 4 | 5 | 6 |
|---|---|---|---|---|---|---|
| C12-15 alkyl polyethoxylate | 16.0 | 16.0 | 14.6 | 8.0 | 20.1 | 7.3 |
| (1.8) sulfate¹ | | | | | | |
| C12 alkyl trimethyl | — | — | — | — | 2.0 | — |
| ammonium chloride² | | | | | | |
| C16/C17 Sodium | 1.9 | 1.9 | 1.7 | — | — | 0.85 |
| Alkylsulfonate (HSAS)³ | | | | | | |
| Sodium | 4.5 | 4.9 | 4.4 | 3.5 | — | 2.0 |
| alkylbenzenesulfonate³ | | | | | | |
| 1,2 Propane diol/di-ethylene | 4.7 | 4.8 | 4.4 | 2.6 | 4.9 | 2.7 |
| glycol | | | | | | |
| Ethanol | 1.9 | 1.9 | 1.9 | 1.1 | 2.7 | 0.9 |
| Neodol 23-9⁹ | 0.7 | 0.7 | 0.7 | 0.3 | 0.8 | 0.4 |
| C₁₂₋₁₈ Fatty Acid⁴ | 1.6 | 1.6 | 1.4 | 0.5 | 1.0 | 0.7 |
| Citric acid | 3.6 | 3.6 | 3.3 | 1.5 | 3.4 | 1.6 |
| Enzymes, (Protease⁵, | 1.8 | 1.8 | 1.6 | 0.6 | 0.35 | 0.8 |
| amylase⁵) | | | | | | |
| Fluorescent Whitening | 0.21 | 0.19 | 0.19 | 0.07 | 0.08 | 0.13 |
| Agent⁶ | | | | | | |
| DTPA | 0.35 | 0.32 | 0.32 | 0.4 | 0.5 | 0.2 |
| Ethoxylated polyamine⁷ | 2.5 | 1.6 | 1.6 | 1.5 | 0.6 | 0.75 |
| Hydrogenated castor oil | — | 0.12 | 0.12 | 0.6 | 0.12 | 0.1 |
| Ethoxylated hexamethylane | 1.5 | — | — | — | — | — |
| diamine⁸ | | | | | | |
| Polymer from any of the | 0.2 | 0.2 | 0.2 | 0.2 | 0.2 | 0.2 |
| examples P1 to P8 | | | | | | |
| KF-869⁹ | 3.0 | 3.0 | 3.0 | 3.0 | 3.0 | 3.0 |
| Water and adjuncts¹¹ | Balance to 100% | | | | | |
| Ingredient (wt. %) | 7 | 8 | 9 | 10 | 11 | 12 |
| C12-15 alkyl polyethoxylate | 16.0 | 16.0 | 14.6 | 8.0 | 20.1 | 7.3 |
| (1.8) sulfate¹ | | | | | | |
| C12 alkyl trimethyl | — | — | — | — | 2.0 | — |
| ammonium chloride² | | | | | | |
| C16/C17 Sodium | 1.9 | 1.9 | 1.7 | — | — | 0.85 |
| Alkylsulfonate (HSAS)³ | | | | | | |
| Sodium | 4.5 | 4.9 | 4.4 | 3.5 | — | 2.0 |
| alkylbenzenesulfonate³ | | | | | | |
| 1,2 Propane diol/di-ethylene | 4.7 | 4.8 | 4.4 | 2.6 | 4.9 | 2.7 |
| glycol | | | | | | |
| Ethanol | 1.9 | 1.9 | 1.9 | 1.1 | 2.7 | 0.9 |
| Neodol 23-9⁹ | 0.7 | 0.7 | 0.7 | 0.3 | 0.8 | 0.4 |
| C₁₂₋₁₈ Fatty Acid⁴ | 1.6 | 1.6 | 1.4 | 0.5 | 1.0 | 0.7 |
| Citric acid | 3.6 | 3.6 | 3.3 | 1.5 | 3.4 | 1.6 |
| Enzymes, (Protease⁵, | 1.8 | 1.8 | 1.6 | 0.6 | 0.35 | 0.8 |
| amylase⁵) | | | | | | |
| Fluorescent Whitening | 0.21 | 0.19 | 0.19 | 0.07 | 0.08 | 0.13 |
| Agent⁶ | | | | | | |
| DTPA | 0.35 | 0.32 | 0.32 | 0.4 | 0.5 | 0.2 |
| Ethoxylated polyamine⁷ | 2.5 | 1.6 | 1.6 | 1.5 | 0.6 | 0.75 |
| Hydrogenated castor oil | — | 0.12 | 0.12 | 0.6 | 0.12 | 0.1 |
| Ethoxylated hexamethylane | 1.5 | — | — | — | — | — |
| diamine¹⁰ | | | | | | |
| Polymer from any of the | 0.3 | 0.3 | 0.3 | 0.3 | 0.5 | 0.5 |
| examples P1 to P8 | | | | | | |
| Silicone¹¹ | — | 3.0 | — | 5.0 | 1.0 | — |
| TDA¹² | 0.3 | 0.2 | 0.5 | 0.2 | 0.15 | 0.3 |

| | |
|---|---|
| Water and adjuncts¹³ | Balance to 100% |

¹Available from Shell Chemicals, Houston, TX
²Available from Degussa Corporation, Hopewell, VA.
³Available from Shell Chemicals, Houston, TX.
⁴Available from The Procter & Gamble Company, Cincinnati, OH.
⁵Available from Genencor International, South San Francisco, CA.
⁶Available from Ciba Specialty Chemicals, High Point, NC.
⁷Sold under the tradename LUTENSIT ®, available from BASF (Ludwigshafen, Germany) and described in WO 01/05874.
⁸Available from Nippon Shokkabai
⁹Aminofunctional silicones,; KF869, KF867 Shin-Etsu Silicones, Akron OH; CF42-xxx from Momentive Silicones, Akron, OH, USA; a polydimethyl siloxane of viscosity 5000, 10000 Cst available from Gilest, Morrisville, PA, USA and 60,000 centistroke available from Dow Corning Corporation, Midland, MI.
¹¹May include, but not limited to: stabilizers, perfumes, dyes, rheology modifiers, opacifier, cleaning polymers
¹²Polymer P3 from Table 1

### Example 7

### Fabric Enhancers

The following are non-limiting examples of the compositions of the present invention such compositions are made by one or more of the processes of making disclosed in the present specification.

| | Liquid Fabric Enhancer Formulation Examples | | | | |
|---|---|---|---|---|---|
| Ingredient (wt. %) | I | II | III | IV | V |
| FSA^{a} | 12 | 21 | 18 | 14 | 12 |
| Low MW alcohol | 1.95 | 3.0 | 3.0 | 2.28 | 2.28 |
| Rheology modifier^{d,e,} | 1.25^{d} | — | 0.2^{e} | — | 0.2^{e} |
| Perfume | 1.50 | 2.3 | 2.0 | 1.50 | 1.50 |
| Perfume encapsulation | 0.6 | 0.3 | 0.4 | — | 0.15 |
| Phase Stabilizing Polymer^{f} | 0.25 | — | — | 0.142 | 0.25 |
| Suds Suppressor^{g} | — | — | — | — | — |
| Calcium Chloride | 0.10 | 0.12 | 0.1 | 0.45 | 0.55 |
| DTPA^{h} | 0.005 | 0.005 | 0.005 | 0.005 | 0.005 |
| Preservative (ppm)ⁱ | 5 | 5 | 5 | 5 | 5 |
| Antifoam^{j} | 0.015 | 0.15 | 0.11 | 0.011 | 0.011 |
| Polyethylene imines^{l} | 0.15 | 0.05 | — | 0.1 | — |
| Silicone¹¹ | 1.56 | 3.15 | 5.25 | 5.25 | 4.2 |
| Polymer from any of the | 0.2 | 0.3 | 0.4 | 0.4 | 0.4 |
| examples P1 to P8 | | | | | |
| Stabilizing Surfactant^{o} | — | — | 0.5 | 0.2 | 0.2 |
| Dye (ppm) | 40 | 11 | 30 | 40 | 40 |
| Ammonium Chloride | 0.10 | 0.12 | 0.12 | 0.10 | 0.10 |
| HCl | 0.010 | 0.01 | 0.10 | 0.010 | 0.010 |
| Deionized Water | Balance | Balance | Balance | Balance | Balance |

| Ingredient (wt. %) | VI | VII | VIII | IX | X | XI | XII |
|---|---|---|---|---|---|---|---|
| FSA^{a} | 16 | 12 | 5 | 5 | — | — | — |
| FSA^{b} | — | — | — | — | 3.00 | — | — |
| FSA^{c} | — | — | — | — | — | 7 | — |
| FSA^{z} | — | — | — | — | — | — | 12 |
| Low MW alcohol | 1.50 | 2.68 | 0.81 | 0.81 | 0.3 | 0.9 | — |
| Rheology modifier^{d,e,} | — | — | 0.42^{d} | 0.25^{e} | 0.5^{d} | 0.70^{d} | — |
| Perfume | 2.20 | 1.50 | 0.60 | 0.60 | 1.30 | 0.8-1.5 | 2.4 |
| Perfume encapsulation | 0.4 | 0.25 | — | 0.3 | 0.1 | — | — |
| Phase Stabilizing Polymer^{f} | — | 0.25 | — | — | — | — | — |
| Suds Suppressor^{g} | — | — | 0.1 | — | — | 0.1 | — |
| Calcium Chloride | 0.350 | 0.545 | — | — | — | 0.1-0.15 | 0.05 |
| DTPA^{h} | 0.005 | 0.007 | 0.002 | 0.002 | 0.20 | — | 0.05 |
| Preservative (ppm)ⁱ | 5 | 5 | 5 | 5 | — | 250 | 75 |
| Antifoam^{j} | 0.011 | 0.011 | 0.015 | 0.015 | — | — | 0.005 |
| Polyethylene imines^{l} | — | 0.1 | — | 0.05 | — | — | — |
| Particle according to present | 1.56 | 3.15 | 5.25 | 5.25 | 4.2 | 4.2 | 1.56 |
| invention comprising | | | | | | | |
| Silicone^{m} and Polymer P3 | | | | | | | |
| from Table 1 in ratio of | | | | | | | |
| (20:1) | | | | | | | |
| PDMS emulsionⁿ | — | — | 0.25 | — | — | — | — |
| Stabilizing Surfactan^{o} | 0.1 | 0.2 | — | — | — | — | — |
| Organosiloxane polymer^{p} | 2 | — | — | — | — | 0-5.0 | 3.0 |
| Amino-functional silicone | — | 2 | — | — | — | 0-5.0 | — |
| Dye (ppm) | 40 | 40 | 30 | 30 | 11 | 30-300 | 30-300 |
| Ammonium Chloride | 0.10 | 0.115 | — | — | — | — | — |
| HCl | 0.010 | 0.010 | 0.011 | 0.011 | 0.016 | 0.025 | 0.01 |
| Deionized Water | Balance | Balance | Balance | Balance | Balance | Balance | Balance |

^{a}N,N-di(tallowoyloxyethyl)-N,N-dimethylammonium chloride.
^{b}Methyl bis(tallow amidoethyl)2-hydroxyethyl ammonium methyl sulfate.
^{c}Reaction product of Fatty acid with Methyldiethanolamine in a molar ratio 1.5:1, quaternized with Methylchloride, resulting in a 1:1 molar mixture of N,N-bis(stearoyl-oxy-ethyl) N,N-dimethyl ammonium chloride and N-(stearoyl-oxy-ethyl) N,-hydroxyethyl N,N dimethyl ammonium chloride.
^{Z}The Reaction product of fatty acid with an iodine value of 40 with methyl/diisopropylamine in a molar ratio from about 1.86 to 2.1 fatty acid to amine and quaternized with methyl sulfate.
^{d}Cationic high amylose maize starch available from National Starch under the trade name HYLON VII ®.
^{e}Cationic polymer available from Ciba under the name Rheovis CDE.
^{f}Copolymer of ethylene oxide and terephthalate having the formula described in U.S. Pat. No. 5,574,179 at col.15, lines 1-5, wherein each X is methyl, each n is 40, u is 4, each R1 is essentially 1,4-phenylene moieties, each R2 is essentially ethylene, 1,2-propylene moieties, or mixtures thereof.
^{g}SE39 from Wacker.
^{h}Diethylenetriaminepentaacetic acid.
ⁱKoralone B-119 available from Rohm and Haas Co. “PPM” is “parts per million.”
^{j}Silicone antifoam agent available from Dow Corning Corp. under the trade name DC2310.
^{l}Polyethylene imines available from BASF under the trade name Lupasol.
^{m}Aminofunctional silicones,; KF869, KF867 Shin-Etsu Silicones, Akron OH; CF42-xxx from Momentive Silicones, Akron, OH, USA; a polydimethyl siloxane of viscosity 5000, 10000 Cst available from Gilest, Morrisville, PA, USA and 60,000 centistroke available from Dow Corning Corporation, Midland, MI.
ⁿTDA silicone pendent cationic acrylamide, silicone modified polyethyleneimine, supplied by BASF, 67056 Ludwigshafen, Germany,
^{p}Organosiloxane polymer condensate made by reacting hexamethylenediisocyanate (HDI), and a, w silicone diol and 1,3-propanediamine, N′-(3-(dimethylamino)propyl)-N,N-dimethyl-Jeffcat Z130) or N-(3-dimethylaminopropyl)-N,Ndiisopropanolamine (Jeffcat ZR50) commercially available from Wacker Silicones, Munich, Germany.

### Example 8

### Use of Fabric Enhancers

The fluid fabric enhancer active formulations in Examples I-XII are used to soften fabrics. The formulations are used in a laundry rinse of an automatic laundry washing machine. Upon completion of the rinse, the fabrics are either machine dried or line dried.

### Example 9

### Unit Dose

Each of the fluid fabric enhancer active formulations of Examples I-XII are also placed in a unit dose packaging comprising a film that surrounds each formulations./ Such unit does are used by adding the unit dose to the wash liquor and/or the rinse. Upon completion of the rinse, the fabrics are either machine dried or line dried.

### Example 10

### PEI Polymers

The following polymers are prepared according to the process described in the patent WO 2008051221:
PEI (2 mol)+25.0 g SGE (0.004 mol)
PEI (2 mol)+20.0 g SGE (0.02 mol)
PEI (2 mol)+25.0 g SGE (0.004 mol)

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A fabric and home care composition comprising:
a) a hydrophobically modified cationic polymer, said hydrophobically modified cationic polymer having the formula:
PᵣSₓ
wherein r is a number from about 10 to about 10,000, and S is a hydrophobic moiety and the index x is a number from about 1 to a number that is equal to about r/10; and P is selected from the group consisting of:
(i) a polyethyleneimine;
(ii) a substituted polyethyleneimine;
(iii) a synthetic polymer comprising a residue of a monomers selected from the group consisting of N,N-dialkylaminoalkyl acrylate; N,N-dialkylaminoalkyl methacrylate; N,N-dialkylaminoalkyl acrylamide; N,N-dialkylaminoalkylmethacrylamide; quaternized N,N dialkylaminoalkyl acrylate; quaternized N,N-dialkylaminoalkyl methacrylate; quaternized N,N-dialkylaminoalkyl acrylamide; quaternized N,N-dialkylaminoalkylmethacrylamide; Methacryloamidopropyl-pentamethyl-1,3-propylene-2-ol-ammonium dichloride; N,N,N,N′,N′,N″,N″-heptamethyl-N″-3-(1-oxo-2-methyl-2-propenyl)aminopropyl-9-oxo-8-azo-decane-1,4,10-triammonium trichloride; vinylamine; allylamine; vinyl imidazole; quaternized vinyl imidazole; diallyl dialkyl ammonium chloride, N-vinyl pyrrolidone, glycidyl methacrylate, acrylamide, N-alkyl acrylamide and mixtures thereof;
and S has the formula
J_{q}W
wherein:
the index q is 0 or 1; and
each J comprises a moiety selected from the group consisting of 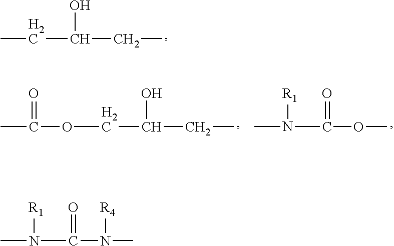
and mixtures thereof wherein each R₁ and R₄ is independently selected from hydrogen or a C₁ to C₄ alkyl,
each X and M are divalent alkylene radicals which are optionally interrupted with N or O;
p is an integer from 1-4; and
W comprises a siloxane polymer or a functionalized siloxane polymer;
b) optionally, a benefit agent;
c) optionally, a surfactant selected from the group consisting of anionic surfactants, cationic surfactants, non-ionic surfactants, amphoteric surfactants and mixtures thereof.

2. The fabric and home care composition of claim 1 wherein, P is selected from the group consisting of:
(i) a polyethyleneimine;
(ii) a substituted polyethyleneimine;
(iii) a synthetic polymer comprising a residue of a monomers selected from the group consisting of N,N-dialkylaminoalkyl acrylate; N,N-dialkylaminoalkyl methacrylate; N,N-dialkylaminoalkyl acrylamide; N,N-dialkylaminoalkylmethacrylamide; quaternized N,N dialkylaminoalkyl acrylate; quaternized N,N-dialkylaminoalkyl methacrylate; quaternized N,N-dialkylaminoalkyl acrylamide; quaternized N,N-dialkylaminoalkylmethacrylamide; Methacryloamidopropyl-pentamethyl-1,3-propylene-2-ol-ammonium dichloride; N,N,N,N′,N′,N″,N″-heptamethyl-N″-3-(1-oxo-2-methyl-2-propenyl)aminopropyl-9-oxo-8-azo-decane-1,4,10-triammonium trichloride; vinylamine; allylamine; vinyl imidazole; quaternized vinyl imidazole; diallyl dialkyl ammonium chloride, and mixtures thereof.

3. The fabric and home care composition of claim 1 wherein P is a random copolymer that comprises, based on total random copolymer weight, a residue of a monomer selected from the group consisting of diallyl dialkyl ammonium chloride, N-vinyl pyrrolidone, glycidyl methacrylate, acrylamide, N-alkyl acrylamide and mixtures thereof.

4. The fabric and home care composition of claim 3 wherein P is a random copolymer that comprises, based on total random copolymer weight:
(i) from about 0 weight percent to about 80 weight percent of a residue of N-vinyl pyrrolidone;
(ii) from about 0.01 weight percent to about 20 weight percent of a residue of glycidyl methacrylate;
(iii) from about 5 weight percent to about 95 weight percent of a residue of diallyldimethylammonium chloride;
(iv) from about 5 weight percent to about 95 weight percent of a residue of acrylamide;
(v) from about 5 weight percent to about 95 weight percent of a residue of N-alkyl acrylamide; and
(vi) combinations of (i) through (v),
with the proviso that the total sum of said residues does not exceed 100%.

5. A fabric and home care composition according to claim 1 wherein:
R₁ and R₄ are hydrogen;
J is selected from the group consisting of 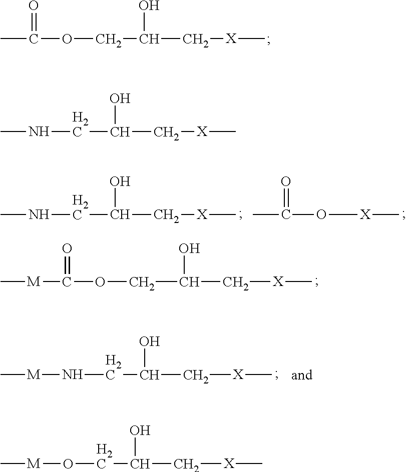
X is selected from the group consisting of 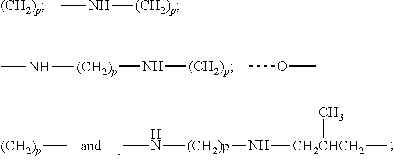
and
said siloxane polymer is polydimethylsiloxane and said functionalized siloxane polymer is functionalized polydimethylsiloxane.

6. A fabric and home care composition according to claim 1 wherein the composition comprises a benefit agent, the ratio of said benefit agent to hydrophobically modified cationic polymer being from about 40:1 to about 5:1.

7. A fabric and home care composition according to claim 6 wherein the benefit agent is selected from the group consisting of a silicone, a vinyl polymer, a polyether, a material comprising a hydrocarbon wax, a hydrocarbon liquid, a fluid sugar polyester, a fluid sugar polyether, perfume raw materials, perfume delivery system, silicone oils, waxes, hydrocarbons, higher fatty acids, essential oils, lipids, skin coolants, vitamins, sunscreens, antioxidants, glycerine, catalysts, bleach particles, silicon dioxide particles, malodor reducing agents, odor-controlling materials, chelating agents, antistatic agents, softening agents, insect and moth repelling agents, colorants, antioxidants, chelants, bodying agents, drape and form control agents, smoothness agents, wrinkle control agents, sanitization agents, disinfecting agents, germ control agents, mold control agents, mildew control agents, antiviral agents, drying agents, stain resistance agents, soil release agents, fabric refreshing agents and freshness extending agents, chlorine bleach odor control agents, dye fixatives, dye transfer inhibitors, color maintenance agents, optical brighteners, color restoration/rejuvenation agents, anti-fading agents, whiteness enhancers, anti-abrasion agents, wear resistance agents, fabric integrity agents, anti-wear agents, anti-pilling agents, defoamers, anti-foaming agents, UV protection agents, sun fade inhibitors, anti-allergenic agents, enzymes, water proofing agents, a hueing dye, fabric comfort agents, shrinkage resistance agents, stretch resistance agents, stretch recovery agents, skin care agents, glycerin, and natural actives, antibacterial actives, antiperspirant actives, cationic polymers, dyes and mixtures thereof.

8. A fabric and home care composition according to claim 6 wherein the benefit agent comprises a silicone.

9. A fabric and home care composition according to claim 7 wherein the silicone comprises an organofunctional silicone.

10. A fabric and home care composition according to claim 7 wherein said organofunctional silicone has the structure:
[R₁R₂R₃SiO_{1/2}]₍ⱼ₊₂₎[R₄Si(X-Z)O_{2/2}]ₖ[R₄R₄SiO_{2/2}]ₘ[R₄SiO_{3/2}]ⱼ
wherein:
j is an integer from 0 to about 98;
k is an integer from 0 to about 200; when k=0, at least one of R₁, R₂ or R₃=—X-Z,
m is an integer from 4 to about 5,000;
R₁, R₂ and R₃ are each independently selected from the group consisting of H, OH, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, C₁-C₃₂ alkoxy, C₁-C₃₂ substituted alkoxy and X-Z;
each R₄ is independently selected from the group consisting of H, OH, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, C₁-C₃₂ alkoxy and C₁-C₃₂ substituted alkoxy;
for each X-Z, X comprises a divalent alkylene radical comprising 2-12 carbon atoms; and
at least one Z in the said organosiloxane is selected from the group consisting of R₅; 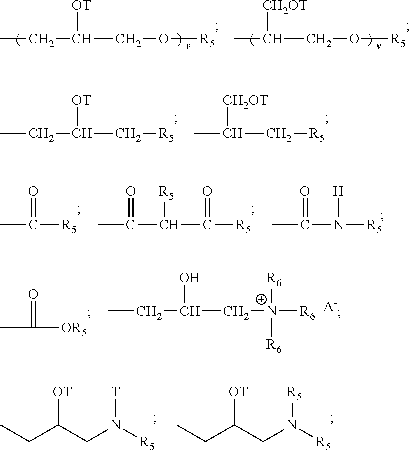
each additional Z in said organosilicone is independently selected from the group comprising of H, C₁-C₃₂ alkyl, C₁-C₃₂ substituted alkyl, C₅-C₃₂ or C₆-C₃₂ aryl, C₅-C₃₂ or C₆-C₃₂ substituted aryl, C₆-C₃₂ alkylaryl, C₆-C₃₂ substituted alkylaryl, R₅, 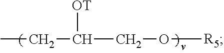
each R₅ is independently selected from the group consisting of H; C₁-C₃₂ alkyl; C₁-C₃₂ substituted alkyl, C₅-C₃₂ or C₆-C₃₂ aryl, C₅-C₃₂ or C₆-C₃₂ substituted aryl or C₆-C₃₂ alkylaryl, or C₆-C₃₂ substituted alkylaryl, —(CHR₆—CHR₆—O—)_{w}—CHR₆—CHR₆-L and a siloxyl residue;
w is an integer from 0 to about 500;
each R₆ is independently selected from H or a C₁-C₁₈ alkyl;
wherein each L is independently selected from 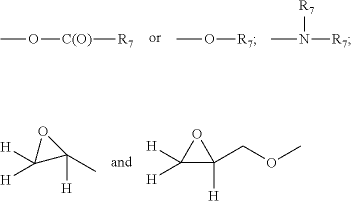
each R₇ is independently selected from the group consisting of H; C₁-C₃₂ alkyl; C₁-C₃₂ substituted alkyl, C₅-C₃₂ or C₆-C₃₂ aryl, C₅-C₃₂ or C₆-C₃₂ substituted aryl, C₆-C₃₂ alkylaryl, and C₆-C₃₂ substituted aryl, and a siloxyl residue;
each T is independently selected from H; 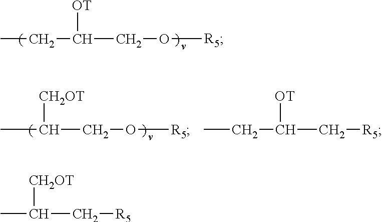
wherein each v in said organosilicone is an integer from 1 to about 10 and the sum of all v indices in each Z in the said organosilicone is an integer from 1 to about 30, with the proviso that the total moieties T in a molecule does not exceed 6.

11. A fabric and home care composition according to claim 8 wherein the index j is an integer from 0 to about 48; the index k is an integer from 0 to about 50; the index m is an integer from about 10 to about 4,000; the index w is an integer from 0 to about 200; v is an integer from 1 to 5 and the sum of all v indices in each Z in the said organosilicone is an integer from 1 to about 20.

12. A fabric and home care composition according to claim 9 wherein the index j is 0; the index m is an integer from about 50 to about 2,000; the index w is an integer from 0 to about 50; and the sum of all v indices in each Z in the said organosilicone is an integer from 1 to about 10.

13. The fabric and home care composition of claim 7 wherein said silicone has a viscosity from about 10 centistokes (cSt) to about 2,000,000 cSt.

14. A fabric and home care composition according to claim 1 wherein the synthetic polymer comprises a residue of an ethylenically unsaturated monomer.

15. A fabric and home care composition according to claim 11 wherein said ethylenically unsaturated monomer is selected from the group consisting of acrylamide; N,N-dialkyl acrylamide; methacrylamide; N,N-dialkylmethacrylamide; C₁-C₁₂ alkyl acrylate; C₁-C₁₂ hydroxyalkyl acrylate; polyalkylene glycol acrylate; C₁-C₁₂ alkyl methacrylate; C₁-C₁₂ hydroxyalkyl methacrylate; polyalkylene glycol methacrylate; vinyl acetate; vinyl alcohol; vinyl formamide; vinyl acetamide; vinyl alkyl ether; vinyl pyridine; vinyl pyrrolidone; vinyl morpholine; acryloyl morpholine; acrylic acid; methacrylic acid; maleic acid; vinyl sulfonic acid; styrene sulfonic acid; acrylamidopropylmethane sulfonic acid, salts of acrylic acid; salts of methacrylic acid; salts of maleic acid; salts of vinyl sulfonic acid; salts of styrene sulfonic acid; salts of acrylamidopropylmethane sulfonic acid, esterified acrylic acid; esterified methacrylic acid; esterified maleic acid; esterified vinyl sulfonic acid; esterified styrene sulfonic acid; esterified acrylamidopropylmethane sulfonic acid, amidated acrylic acid; amidated methacrylic acid; amidated maleic acid; amidated vinyl sulfonic acid; amidated styrene sulfonic acid; amidated acrylamidopropylmethane sulfonic acid; ethylene glycoldiacrylate; divinylbenzene; butadiene and mixtures thereof.

16. The fabric and home care composition of claim 1, comprising one or more additives in addition to said benefit agent, said additives being selected from the group consisting of bleach, bleach activators, surfactants, builders, chelating agents, dye transfer inhibiting agents, dispersants, enzymes, enzyme stabilizers, catalytic metal complexes, polymers, polymeric dispersing agents, clay and soil removal/anti-redeposition agents, brighteners, suds suppressors, dyes, perfumes, perfume delivery systems, structure elasticizing agents, fabric softeners, carriers, hydrotropes, solvents, processing aids, and pigments.

17. The fabric and home care composition of claim 1 wherein said hydrophobically modified cationic polymer disposed, at least in part, on a particle comprising a core having an outer surface and one or more layering materials, said particle having a particle size of from about 0.02 um to about 500 um.

18. The fabric and home care composition of claim 15 wherein said hydrophobically modified cationic polymer is disposed, at least in part, on the outer surface of said particle's core.

19. A method of treating a situs comprising optionally, washing and/drying a situs, contacting a situs with a composition according to any of claims 1-17 then optionally, washing and/drying said situs.
